(19) United States
(12) Patent Application Publication
(10) Pub. No.: US 2021/0153656 A1
(43) Pub. Date: May 27, 2021

(54) FOLDING CHAIR

(71) Applicant: Wyldly, LLC, Temecula, CA (US)

(72) Inventors: Robert F. Hudiburg, Temecula, CA (US); Jared ROSENTHAL, Temecula, CA (US); Brian FINNESTAD, Temecula, CA (US); Peter SZUCS, Temecula, CA (US); Andrew HABEDANK, Temecula, CA (US)

(21) Appl. No.: 17/102,023

(22) Filed: Nov. 23, 2020

Related U.S. Application Data
(60) Provisional application No. 63/081,510, filed on Sep. 22, 2020.
(60) Provisional application No. 63/014,020, filed on Apr. 22, 2020.
(60) Provisional application No. 62/941,191, filed on Nov. 27, 2019.

(51) Int. Cl. A47C 4/28; A47C 1/02; A47C 3/025; A47C 7/62

(52) U.S. Cl. CPC A47C 4/28; A47C 7/624; A47C 3/0255; A47C 1/02

(57) ABSTRACT

A folding chair includes a backrest and a pair of armrests pivotally coupled to the backrest. A pair of rear legs are pivotally coupled to the backrest and define a rear leg angle therebetween. A pair of front legs are pivotally coupled to respective armrests and define a front leg angle therebetween. A pair of wheels are coupled to the backrest. The folding chair is positionable in a deployed configuration wherein distal ends of the rear and front legs are in coplanar alignment. The folding chair is also positionable in a folded configuration wherein distal ends of the rear legs and the front legs are in non-coplanar alignment with each other and the wheels are positioned to roll the folding chair on a support surface. The rear and front leg angles decreasing as the folding chair transitions from the deployed configuration toward the folded configuration.

### CROSS-REFERENCE TO RELATED APPLICATIONS

This application claims the benefit of U.S. Provisional Application No. 63/081,510 filed Sep. 22, 2020, U.S. Provisional Application No. 63/014,020 filed Apr. 22, 2020, and U.S. Provisional Application No. 62/941,191 filed Nov. 27, 2019, the contents of each of which are expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to portable folding chairs, and more particularly, to a folding chair specifically configured and adapted to enhance the overall comfort to a user seated in the chair, while additionally enhancing the ease of stowing and transporting the chair when not in use.

### 2. Description of the Related Art

Folding chairs are well known and are commonly used in areas where permanent seating does not exist or may not be practical. For instance, folding chairs may be used during outdoor sporting events, such as youth sports events, e.g., soccer, little league, etc., as well as use at the beach, or while camping, or even during a backyard barbeque.

Conventional folding chairs typically include a frame that is transitional between a deployed position and a stowed position. When the frame is in the deployed position, the frame may be arranged so as to allow the folding chair to remain upright on an underlying support surface and provide a seating surface for an individual. When the folding chair is in the stowed position, the frame may partially collapse onto itself, and the seating surface may be moved such that the folding chair may assume a more compact configuration, more suitable for storage or transport of the chair.

Although conventional folding chairs may, to a certain degree, aim at satisfying a utilitarian need of providing temporary seating in remote locations, conventional folding chairs suffer from several deficiencies. One particular deficiency that is common among conventional folding chairs is that overall comfort of the chair may be sacrificed in favor of enabling the folding motion of the chair. Along these lines, there may be limited padding or seat adjustment capability to minimize interference when folding the chair.

Another deficiency commonly associated with conventional folding chairs is that it may be difficult for one person to personally transport or carry multiple chairs. In many instances, multiple folding chairs may be used during a given occasion, e.g., a family beach outing, a group camping trip, etc. When multiple folding chairs are used, each chair must typically be individually carried, which may be tedious and time consuming.

Conventional folding chairs also suffer from being limited in options that may be integrated into the folding chair. Indeed, many conventional folding chairs are aimed at minimizing their overall weight and their ability to assume a compact configuration, and thus, many existing folding chairs simply include the chair with no accessories.

Accordingly, there is a need in the art for a folding chair that provides enhanced comfort and built in accessories, without compromising its ability to transition between deployed and stowed configurations. Various aspects of the present disclosure address this particular need, as will be discussed in more detail below.

### BRIEF SUMMARY

In accordance with one embodiment of the present disclosure, there is provided a folding chair comprising a pair of armrests, and a backrest rod extending between the pair of armrests and being moveable relative to the pair of armrests. The folding chair additionally includes a backrest frame connected to the backrest rod, and a lower frame connected to the backrest frame. The backrest frame is transitional relative to the lower frame between a deployed configuration and a folded configuration, with an angle between the lower frame and the backrest frame decreasing as the backrest frame transitions from the deployed configuration toward the folded configuration. The backrest frame is configured to assume a recline position relative to the pair of armrests when the backrest frame is in the deployed position, with the backrest frame being interconnected to the pair of armrests such that the recline position is selectively adjustable within a prescribed range. The backrest frame is interconnected to the pair of armrests and the lower frame to allow for selective pivotal rocking of the backrest frame relative to the lower frame when the backrest frame is in the recline position.

The folding chair may additionally include a pair of cavities located in respective ones of the pair of armrests. A pair of carriages may be located in respective ones of the pair of cavities and interconnected to the backrest rod such that the pair of carriages translate within the respective cavity to facilitate the selective pivotal rocking of the backrest frame. The folding chair may also include a pair of springs, with each spring being connected to a respective one of the pair of armrests and a respective one of the pair of carriages to impart a dampening force on the respective carriage.

A pair of sliders may be connected to the backrest rod and respective ones of the pair of carriages. The pair of sliders may translate relative to the respective ones of the pair of carriages to facilitate the selective adjustment of the recline position. A pair of guide rails may be coupled to respective ones of the pair of sliders, the pair of sliders being translatable along respective ones of the pair of guide rails.

Each slider may include a bore which receives a portion of the backrest rod. The backrest rod may be moveable within each bore between a first position and a second position. Each slider may be moveable within the respective one of the pair of carriages when the backrest rod is in the second position.

The folding chair may additionally include a pair of clamps connected to respective ones of the pair of sliders and respective ones of the pair of guide rails and configured to inhibit movement of the respective slider along the respective guide rail when the backrest rod is in the first position.

The folding chair may also include a headrest moveable relative to the backrest frame between a stowed position and an extended position, the headrest moving away from the pair of armrests as the headrest moves from the stowed position toward the extended position when the backrest frame is in the deployed configuration. The headrest may translate relative to the backrest frame as it transitions between the stowed position and the extended position.

The folding chair may additionally include a pair of wheels coupled to the backrest frame or the lower frame.

The folding chair may further comprise a charging port located in one of the pair of armrests. The charging port may be removeably coupled to the one of the pair of armrests within which the charging port is located.

The folding chair may also include a support bracket pivotally coupled to the backrest frame.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is an upper perspective view of a folding chair;

FIG. 2 is an upper perspective view of the folding chair of FIG. 1 in a partially folded configuration;

FIG. 3 is a perspective view of the folding chair of FIG. 1 in a fully folded configuration;

FIG. 4 is an enlarged lower perspective view of the folding chair of FIG. 1 illustrating a lower support plate to which the legs and back support frame are pivotally coupled;

FIG. 5 is an enlarged side view of the folding chair, with the legs being transparent to depict a lower support plate to which the legs and backrest frame are pivotally connected;

FIG. 6 is an upper perspective view of the folding chair of FIG. 1, depicting a headrest as being transitioned to an extended position;

FIG. 7 is an upper perspective view of the folding chair of FIG. 1, depicting an armrest charging compartment thereof in an opened configuration;

FIG. 8 is an enlarged upper perspective view of the armrest charging compartment depicted in FIG. 7;

FIG. 9 is a lower perspective view of the folding chair of FIG. 1 in the fully folded configuration, further depicting a support bracket in a stowed configuration;

FIG. 10 is an upper perspective view of the folding chair of FIG. 1, with the support bracket being depicted as transitioned to a deployed configuration;

FIG. 11 is an upper perspective view of the folding chair of FIG. 1, with the support bracket in the deployed configuration, and a handle of the chair being depicted in an extended configuration;

FIG. 12 is an upper perspective, partially exploded view of an armrest internal assembly and backrest rod corresponding to the backrest being in the upright position;

FIG. 13 is an upper perspective, partially exploded view of the armrest assembly and backrest rod corresponding to the backrest being in the reclined position;

FIG. 14 is an upper perspective view of the armrest internal assembly;

FIG. 15 is a lower perspective view of the armrest internal assembly;

FIG. 16 is a top view of the armrest internal assembly;

FIG. 17 is a side view of the armrest internal assembly;

FIG. 18 is a cross-sectional side view of the armrest internal assembly;

FIG. 19 is an exploded upper perspective view of the armrest internal assembly;

FIG. 20 is an enlarged perspective view of an armrest internal assembly corresponding to the backrest being in the upright position;

FIG. 21 is an enlarged perspective view of the armrest internal assembly corresponding to the backrest being in the reclined position;

FIG. 22 is a partial side view of the armrest internal assembly and backrest in the upright position;

FIG. 23 is a partial side view of the armrest internal assembly and backrest in the reclined position;

FIG. 24 is a bottom view of the front portion of the folding chair including an actuator for facilitating the folding of the folding chair to the collapsed state;

FIG. 25 is an upper perspective, partial exploded view of the front portion of the folding chair;

FIG. 26 is a bottom view of the actuator assembly;

FIG. 27 is a top view of the actuator assembly;

FIG. 28 is an upper perspective view of the actuator assembly;

FIG. 29 is a top view of an actuating assembly for facilitating the extension of a top portion of the backrest; and

FIG. 30 is a side view of a lock body, cable and spring for locking the top portion of the backrest.

Common reference numerals are used throughout the drawings and the detailed description to indicate the same elements.

### DETAILED DESCRIPTION

Referring now to the drawings, wherein the showings are for purposes of illustrating preferred implementations of the present disclosure, and are not for purposes of limiting the same, there is depicted a folding chair 1000 having several attributes which enhance the overall comfort and ease of use of the folding chair 100. In this regard, as will be described in more detail below, the folding chair 100 may be specifically configured and adapted to allow for quick and easy transition between a folded configuration and a deployed configuration, while at the same time, enhancing the overall comfort for the individual seated within the folding chair 100. Furthermore, the folding chair 100 may incorporate one or more accessories or added features aimed at further enriching the experience of an individual seated in the folding chair 100.

According to one embodiment, the folding chair 100 may include generally include a backrest 104, a lower seat support 105, a pair of armrests 114, a pair of forward legs 134 and a pair of rear legs 136. The backrest 104 of the chair 100 may include a main portion 106, a pair of side portions 108 and a headrest 102. The backrest 104 may further include a backrest frame 146 and backrest pads attached to the backrest frame 146. The backrest frame 146 may include rigid elements that extend along the lateral sides of the chair 100, as well as the top of the chair 100 between the laterally positioned rigid elements. Rigid elements may also extend transversely at the bottom of the backrest frame 146 as well as at a middle portion of the backrest frame 146 (e.g., at a region between the top and bottom of the backrest frame 146).

The backrest frame 146 may be formed as a unitary structure and include a narrow lower section 147 (see FIG. 9) which outwardly flares or transitions into a comparatively wider upper section 149. The narrow lower section 147 may be pivotally connected to a lower support plate 128 providing rigid support to a lower portion of the chair 100 and may define a width that is slightly smaller than the distance between the pair of opposed extensions 144 of the lower support plate 128. The wider upper section 149 may be greater in width that the lower section 147 to provide more space for supporting the upper back of a user seated in the chair 100.

The folding chair 100 may further include a lower leg assembly comprising the forward legs 134, the rear legs 138 and linkages 142 extending between the forward and rear legs 134, 138. The lower leg assembly may be connected to the lower support plate 128 including a front-end portion 130 and a rear end portion 132. The front-end portion 130 may be pivotally coupled to the pair of forward legs 134, such that the pair of forward legs 134 pivot about a common front pivot axis 136. The rear end portion 132 may be pivotally coupled to the pair of rear legs 138, such that the pair of rear legs 138 pivot about a common rear pivot axis 140. The upper end portion of each rear leg 138 may be linked to a middle portion of a corresponding forward leg 134 via linkage 142 to allow the forward and rear legs 134, 138 to pivot in concert with each other.

The lower support plate 128 may form part of a lower frame and may additionally include an extension 144 at the rear end portion thereof, with the extension 144 extending upwardly from a lower edge of the lower support plate 128. The extension 144 includes a distal end portion, which is pivotally connected to the backrest frame 146, such that the backrest frame 146 pivots relative to the extension 144 about a backrest pivot axis 148. The backrest pivot axis 148 is spaced from the rear pivot axis 140 by a distance D, as shown in FIG. 5.

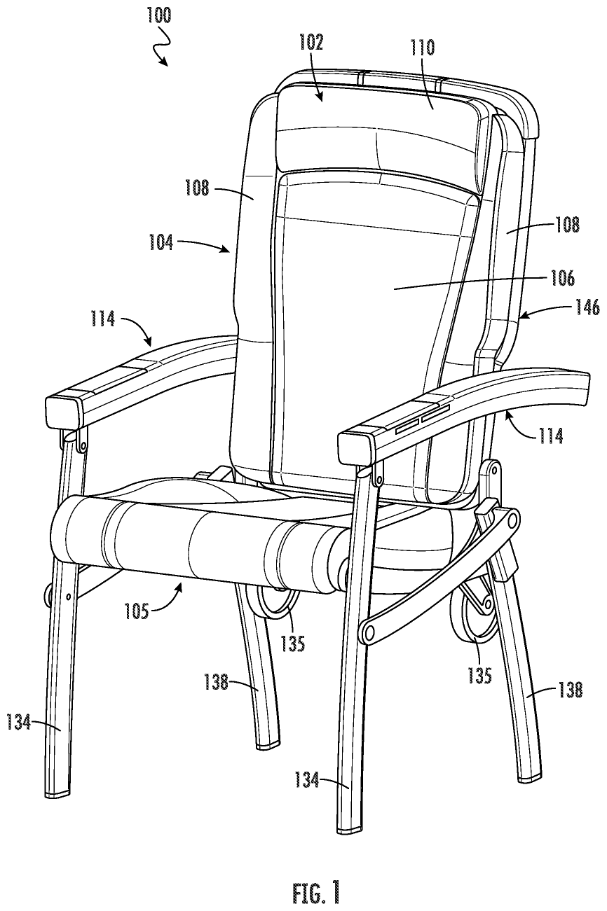

With reference now specifically to FIGS. 1-3, the action of transitioning the folding chair 100 between the deployed configuration and the folded configuration will be described. FIG. 1 shows the folding chair 100 in the deployed configuration. In the deployed configuration, distal end surfaces defined by the legs 134, 138 are generally co-planar to allow the folding chair 100 to be supported on an underlying support surface. Furthermore, in the deployed configuration, the folding chair 100 defines a seating surface that is generally horizontal, and a back-support surface that is generally upright.

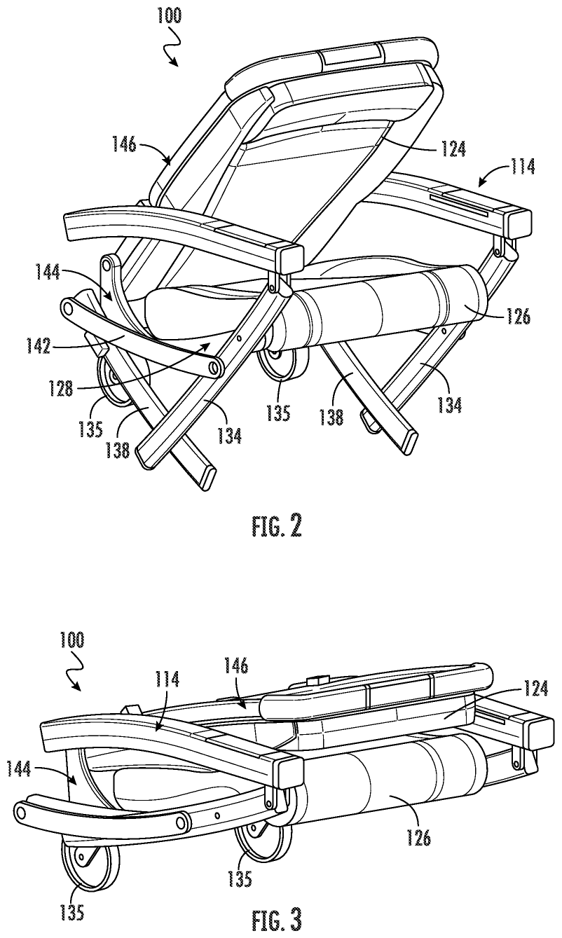

Referring now specifically to FIG. 2, the folding chair 100 depicted therein is in an intermediate position between the deployed and folded configurations. In this regard, the front legs 134 have been pivoted toward armrests 114 such that the front leg angle (e.g., an angle between the front legs 26 and their corresponding armrests 114) therebetween becomes smaller. This motion also brings the front legs 134 toward the rear legs 138, with the rear legs 138 have been pivoted in a forward direction in a manner which results in the rear leg angle (e.g., an angle between the rear legs 138 and their corresponding armrests 114) becoming smaller.

The folding chair 100 may include a pair of wheels 135 integrated therein to facilitate rolling transport of the folding chair 100 when the folding chair 100 is in the folded configuration. Accordingly, the folding chair may be configured such that transition of the folding chair 100 from the deployed configuration to the folded configuration may also cause the wheels 135 to assume a position which is favorable for rolling the folding chair 100 on the ground or other support surface. In this regard, the wheels 135 may extend beyond the distal, terminal ends of the rear legs 138 to form a distal most end portion of the folding chair 100 when the folding chair 100 is in the folded configuration. When the folding chair 100 is in the deployed configuration and the chair 100 is supported by the legs 134, 138, the wheels 135 are spaced from the ground surface.

The folding chair 100 may be configured to accommodate the padding on the lower seat portion, as well as the backrest portion, when the folding chair 100 is articulated between its folded configuration and its deployed configuration. In this regard, the folding chair 100 may allow for pivoting of the backrest portion relative to the lower seat portion such that sufficient space is allotted for the padding as the folding chair 100 is folded into its fully collapsed state. As can be seen in FIG. 3, the backrest padding 124 lies on top of the lower seat padding 126 when fully folded, such that the backrest padding 124 is oriented is generally parallel, overlapping relation to the lower seat padding 126. In this regard, the frame of the folding chair 100 may articulate in a manner which avoids interference between the backrest padding 124 and lower seat padding 126, which may otherwise prevent complete folding of the chair 100.

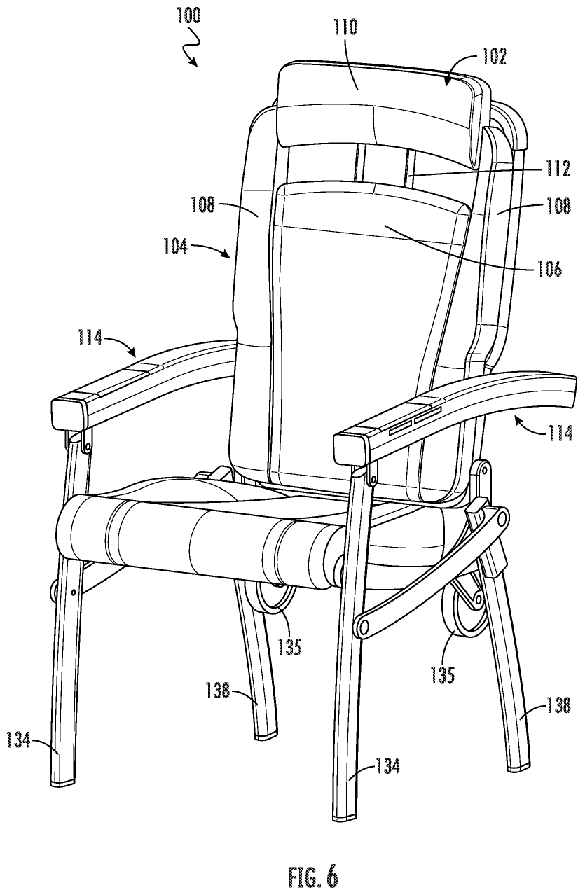

FIGS. 1 and 6 highlight a headrest feature included in the folding chair 100. According to one embodiment, the headrest 102 includes a pad 110 extending between the pair of side portions 108 and connected to a pair of support posts 112, which are received within corresponding slots formed in the main portion 106. Each support post 112 may include one or more notches formed therein, which may interface with a spring-biased locking body coupled to the main portion 106 for locking the headrest pad 110 at one or more preset positions relative to the main portion 106 as the headrest pad 110 transitions between a stowed position and an extended position. When the headrest pad 110 is in the stowed position, a lower surface of the headrest pad 110 is moved adjacent, and possibly in contact with, an upper surface of the main portion 106. When the headrest pad 110 is in the extended position, the lower surface of the headrest pad 110 is moved away from the upper surface of the main portion 106, which results in a void or space being formed between the headrest pad 110 and the main portion 106. Thus, the headrest pad 110 may be selectively positioned between the stowed position and the extended position to accommodate individuals that may vary in height.

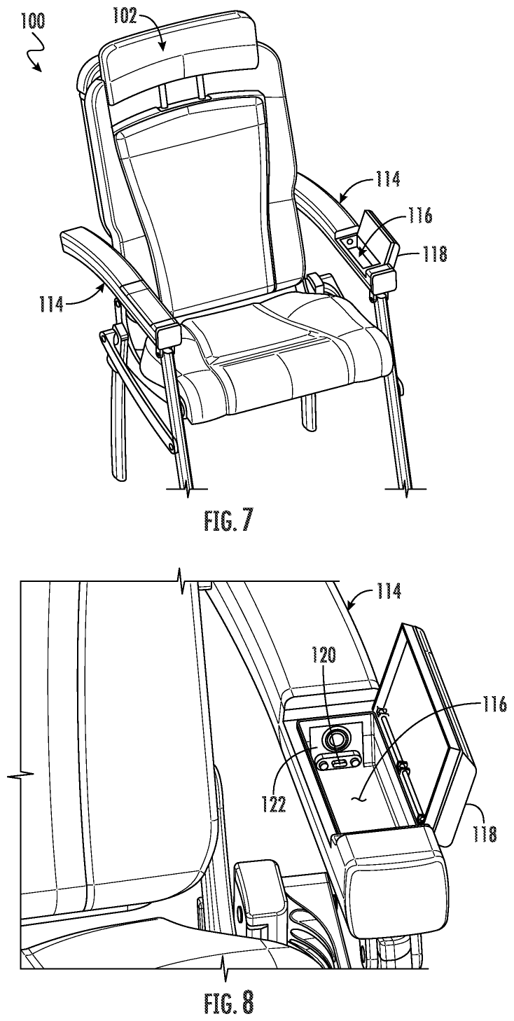

Referring now to FIGS. 7 and 8, the folding chair 100 may include an armrest charging compartment, which is depicted in FIGS. 7 and 8 in an opened configuration. In more detail, one or both of the armrests 114 may include a compartment 116 or cavity formed therein, with a cover 118 pivotally coupled to the armrest 114. When the cover 118 is closed, the compartment 116 is covered and the outer surface of the cover 118 may be generally flush or co-planar with the outer surface of the armrest 114. When the cover 118 is opened, compartment 116 may be accessible to access a charging port 120 located within the compartment 116. The charging port 120 may be a USB port, micro USB port, or other charging ports known by those skilled in the art.

According to one embodiment, the charging port 120 is removably connected to the armrest 114. The charging port 120 may be integrated into a body 122 or block that is insertable into a recess formed in the armrest 114 adjacent the compartment 116. The size and configuration of the body 122 may be complementary to that of the recess. One or more screws may be used to connect the body 122 to the armrest 114. When the body 122 is connected to the armrest 114, the charging port 120 may be in operative electrical communication with a battery or other power supply.

Although the charging port 120 may be used to provide power to a handheld electronic device, such as a smartphone or tablet computer, it is also contemplated that data communications may occur through the charging port 120. In this regard, the charging port 120 may not be limited to simply power transfer but may also allow for data transfer therethrough to other electronic devices that may be integrated into the folding chair 100 or operatively connected to the folding chair 100.

The detachable engagement between the charging port 120 and the armrest 114 may allow for trouble shooting or replacement of the charging port 120 in the event the charging port 52 breaks or stops functioning properly. Though not shown in the Figures, it is contemplated that the wall portion of the armrest 114 which defines the bottom surface of the compartment 116 may include a waterproof grommet or similar structure disposed therein as allows for the passage of an electrical cord from the exterior of the armrest 114 into the interior of the compartment 116 thereof. This arrangement allows one end of the electrical cord to be operatively connected to the charging port 120, with the opposed end being operatively connected to a device such as a smartphone, tablet, etc., while maintaining the cover 118 in its closed configuration.

Referring now to FIGS. 9-11, the folding chair 100 may additionally include a selectively deployable support bracket 150 for supporting a cooler or other item thereon when the chair 100 is articulated to its fully folded state. For instance, if a user needs to transport the chair 100 and the cooler from a vehicle to a remote location, such as a sports field located away from where the vehicle may be parked, the user may place the cooler on the deployed support bracket 150 and wheel the chair 100 from the vehicle to the sports field, which may be much easier than carrying the chair 100 and the cooler separately.

The support bracket 150 may be pivotally coupled to a backrest rod 152, which may extend transversely across the backrest frame 146. The support bracket 150 may include an elongate member 154 and a plurality of pivot arms 156 extending from the elongate member 154 and each being pivotally connected to the backrest rod 152. In the exemplary embodiment, the support bracket 150 includes three pivot arms 156, although it is contemplated that any number of pivot arms 156 may be included without departing from the spirit and scope of the present disclosure. The combination of the pivot arms 156 and the elongate member 154 provide sufficient structure for supporting the cooler against the backrest of the folding chair 100, particularly when the backrest is held at an angle (e.g., not vertical).

The pivot arms 156 may be spaced from each other, such that adjacent pivot arms 156 may form an opening 158 which may be used to attach a strap or the like around the cooler when the cooler is placed on the support bracket 150.

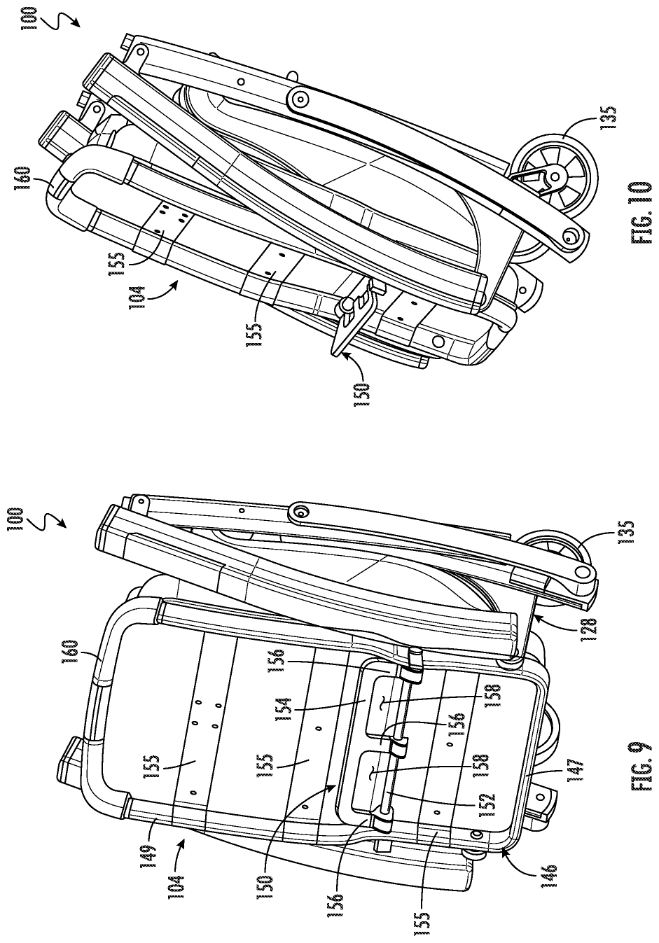

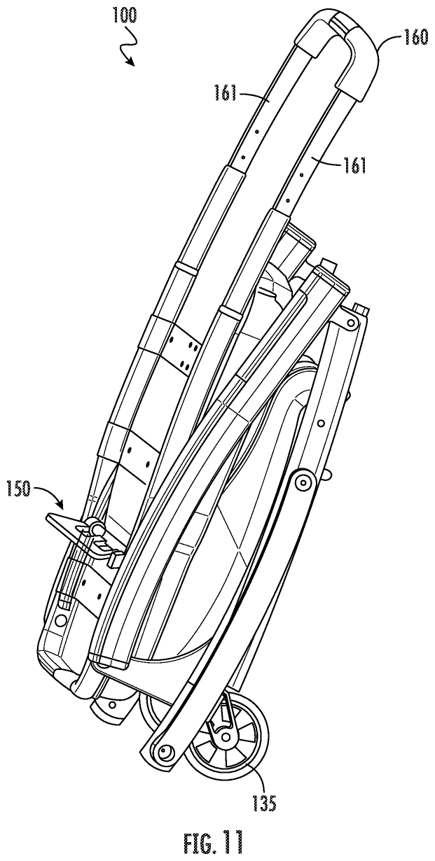

The support bracket 150 may pivot relative to the backrest frame 146 between a stowed position and a deployed position. When in the stowed position, the elongate member 154 may lie adjacent or against the backrest 104 of the folding chair 100, while in the deployed position, the elongate member 154 may be positioned away from the backrest 104, i.e., extending at about a ninety degree angle relative thereto as seen in FIG. 10. In this regard, transitioning the support bracket 150 from the stowed position to the deployed position results in the elongate member 154 being moved away from the backrest 104, while transition of the support bracket 150 from the deployed position toward the stowed position results in the elongate member 154 being moved toward and ultimately into overlapping contact with the backrest 104. Transition of the support bracket 150 between the stowed and deployed positions may also result in the angle defined by the support bracket 150 and the backrest 104 to change, i.e., the transition of the support bracket 150 from the deployed position toward the stowed position resulting in the angle therebetween decreasing, while transition of the support bracket 150 from the stowed position toward the deployed position resulting in the angle therebetween increasing to the aforementioned maximum of about ninety degrees.

The folding chair 100 may include one or more struts 155 or support straps that extend across the backrest frame 146 to aid in supporting the cooler on the backrest 104 of the folding chair 100. In particular, the struts 155 may bear a portion of the weight of the cooler, as well as transfer the weight across the backrest frame 146. The struts 155 may be formed from metal, a woven material (e.g., nylon), leather, plastic, or other materials known in the art. In the exemplary embodiment, there are two struts 155 positioned in the upper portion of the backrest frame 146 above the support bracket 150, and one strut 155 positioned in the lower portion of the backrest frame 146 below the support bracket 150. However, it is understood that the number and placement of struts 55 is provided as an example and is not intended to limit the scope of the present disclosure.

FIG. 11 shows the folding chair 100 in the folded configuration, with the support bracket 150 in the deployed position, with a telescoping handle 160 extended from the remainder of the backrest frame 146 to facilitate rolling of the folding chair 100 along the ground. The telescoping handle 160 may include a pair of extension arms 161 that are received within respective sleeves formed in the lateral rigid portions of the backrest frame 146. The telescoping handle 160 may transition between a closed position (FIGS. 9-10) and an extended position (FIG. 11), such that at least a portion of the extension arms 161 become exposed by extending out of the lateral portions of the backrest frame 146 as the telescoping handle 160 transitions rom the closed position toward the extended position. The telescoping handle 160 may have a spring detent (or similar locking mechanism) which may be received in one of a plurality of holes formed in the backrest frame 148 to lock the telescoping handle 160 in one of a possible plurality of available extended positions. With the support bracket 150 deployed, a cooler or other item may be easily supported thereon while rolling the folding chair 100. In the folding chair 100, it is contemplated that the lengths of the extension arms 161, when fully extended as shown in FIG. 11, will be such that when a user grasps the handle 160, and the folding chair 100 is thereafter tilted toward and pulled behind the user on the wheels 135 in a conventional manner, the clearance between the user's heels when walking with a normal stride and those portions of the folding chair 100 spanning or extending between the wheels 135 will be sufficient to avoid any “kick points.” In other words, the clearance is such that the user will not be prone to constantly kicking the folding chair 100 during the process of pulling it along a surface via its wheels 135.

It is contemplated that the folding chair 100 may be configured to allow multiple folding chairs 100 to be connected or stacked together to allow multiple folding chairs 100 to be collectively transported. To this end, each folding chair 100 may include a hook or bracket on a prescribed portion of the backrest frame 146 which is sized and positioned to be engageable with a prescribed portion of an adjacent folding chair 100. When the adjacent folding chairs 100 are connected, they may be arranged in a daisy chain fashion, thus providing the ability to interconnect several folding chairs 100 as allows a single individual to transport multiple chairs 100. Thus, if a family is using several chairs at an outdoor event, a single person may transport the chairs for the entire family to a vehicle or other location.

During use of the folding chair 100 in the deployed configuration, it is contemplated that certain embodiments of the folding chair 100 may allow for selective adjustment of a recline angle of the backrest 104 relative to the lower seat support 105. Furthermore, the folding chair 100 may be configured to facilitate rocking of the backrest 104 relative to the lower seat support 105. These actions of the backrest 104 may be facilitated by an assembly that extends across the backrest 104 and into the armrests 114.

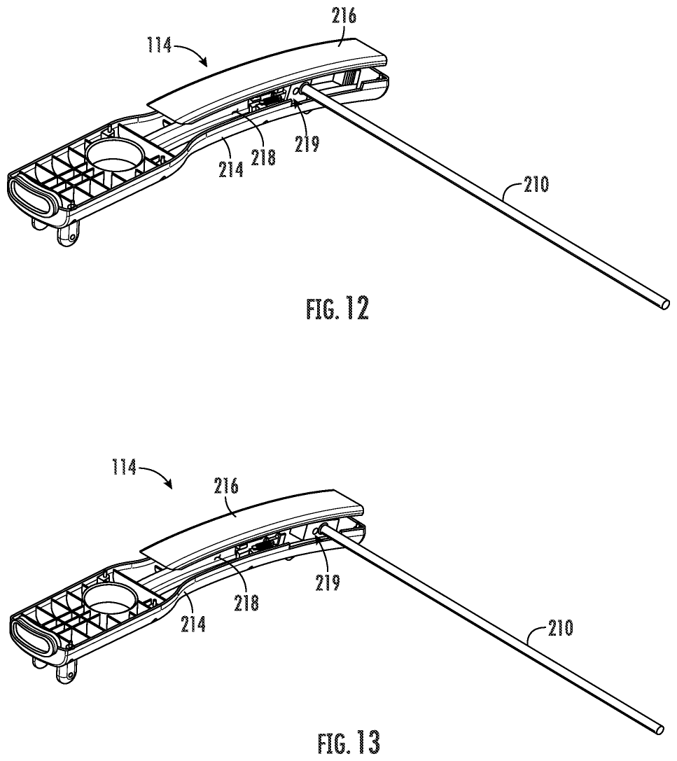

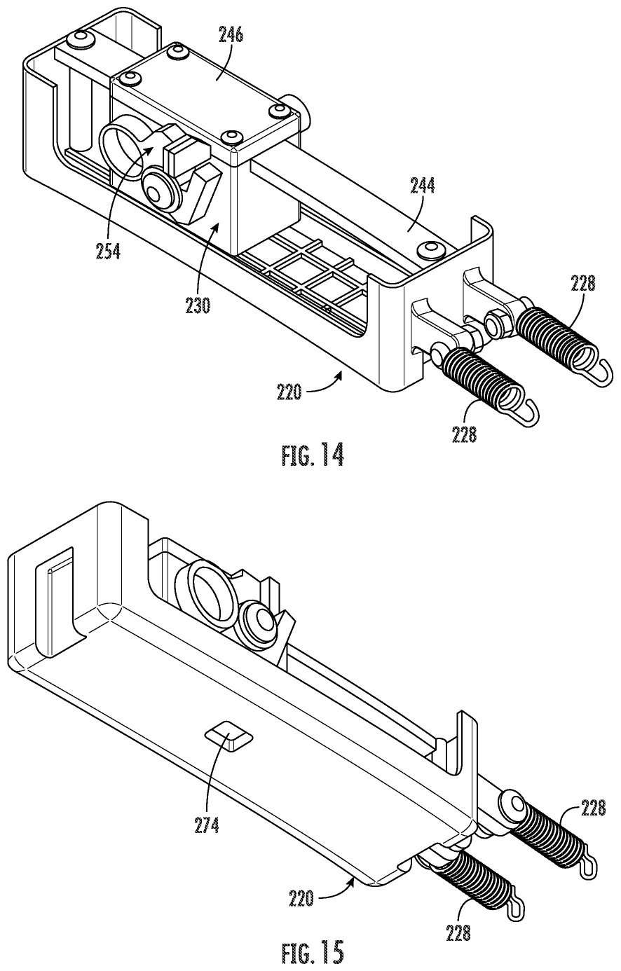

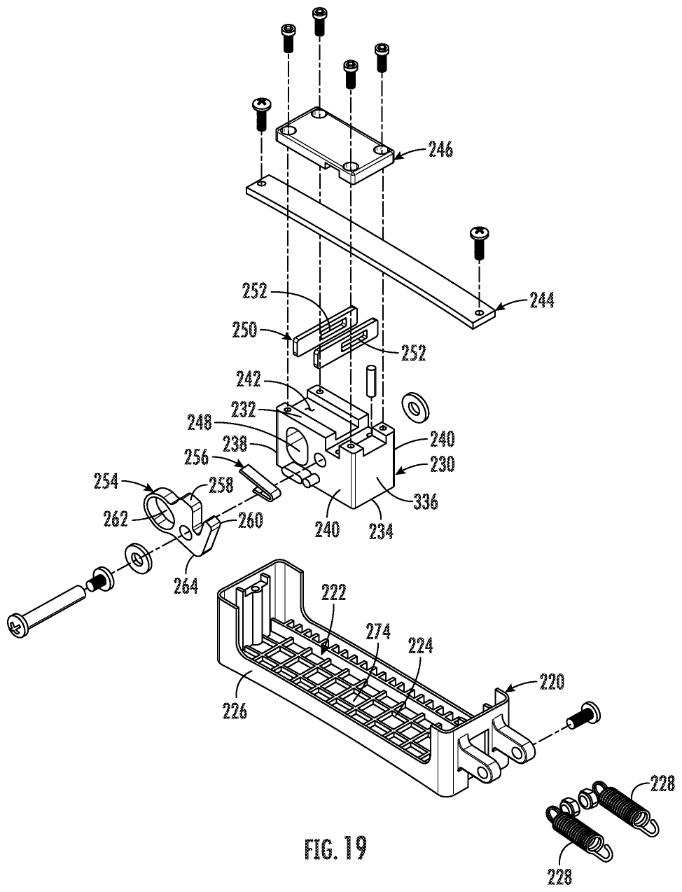

With specific reference now to FIGS. 12-23, each armrest 114 may include a lower body 214 and an upper body 216, which may be connected to each other to collectively define an armrest cavity 218 therein. The armrest 114 may include an internal assembly 219 connected to a backrest rod 210, which may extend across the backrest 104 between the internal assemblies 219 located in the armrests 114. Each internal assembly 219 may be moveable within an armrest cavity 218 to facilitate recline adjustment, as well as to enable rocking of the backrest 104. FIG. 12 shows the internal assembly 219 in a forward position, while FIG. 13 shows the internal assembly 219 in a rearward position.

According to one embodiment, the internal assembly 219 includes a carriage 220 located within the armrest cavity 218 and moveable relative to the lower and upper bodies 214, 216, with such movement allowing for rocking of the backrest 104, as will be described in more detail below. The carriage 220 includes a cavity 222 collectively defined by a lower wall 224 and a plurality of sidewalls 226. The carriage cavity 222 may be open at the top. The carriage 220 may be coupled to one of the lower and upper bodies 214, 216 of the armrest 220 via one or more springs 228, which apply a dampening force to the carriage 220 as the carriage 220 moves from a forward-rock position to a rearward-rock position. In particular, the springs 228 may elongate as the carriage 220 moves from the forward-rock position toward the rearward-rock position, and recoil as the carriage 220 moves from the rearward-rock position toward the forward-rock position.

A slider 230 may be located within the carriage cavity 222 and may be translatable within the carriage cavity 222 between a forward-recline position and a rearward-recline position to facilitate selective, incremental recline adjustment of the backrest 104. The slider 230 includes a top surface 232, a bottom surface 234, a forward surface 236, a rearward surface 238, and a pair of opposed side surfaces 240. The slider 230 further includes a guide slot 242 extending between the forward and rearward surfaces 236, 238, In the exemplary embodiment, the guide slot 242 extends into the slider 230 from the top surface. The guide slot 242 is sized and configured to receive a guide rail 244, which is coupled to the carriage 220 and extends longitudinally in a forward-to-rearward direction (i.e., the direction of recline adjustment). A cover plate 246 may be coupled to the slider 230 to cover the guide slot 242 and capture the guide rail 244 to the slider 230. The interconnection between the guide rail 244 and the slider 230 allows the slider 230 to translate along the guide rail 244 within the carriage cavity 222 between the forward-recline position and rearward-recline position.

The slider 230 may additionally include a bore 248 extending between the pair of opposed side surfaces 240. In this regard, the bore 248 may extend in a generally perpendicular direction relative to longitudinal extension of the guide slot 242. The bore 248 may be sized and configured to receive an end portion of backrest rod 210 and allow for movement of the backrest rod 210 to facilitate recline adjustment of the backrest 104.

The guide slot 242 and cover plate 246 may collectively define a clamp channel configured to receive a pair of clamps 250. In the exemplary embodiment, a portion of the clamp channel extends into the slider 230 and another portion extends into the cover plate 246. The clamps 250 may include a side-by-side pair of metal sheets sized to reside within the clamp channel. Each sheet may include a central opening 252 similar in size to the guide rail 244. The pair of clamps 250 may be sized to frictionally engage the guide rail 244 when a pressure is applied thereto in a prescribed direction, to effectively lock the position of the slider 230 along the guide rail 244 to prevent further translation of the slider 230 along the guide rail 244. When a counteracting force is applied, the locking force applied by the clamps 250 is reduced or eliminated to allow for movement of the slider 230 along the guide rails 244.

The pressure applied to the clamps 250 may be imparted by a camming body 254 rotatably coupled to the slider 230. The camming body 254 may be rotatable relative to the slider 230 between a locking position and an unlocking position. A leaf spring 256 may extend between the camming body 254 and the carriage 220 to impart a biasing force on the camming body 254 which urges the camming body 254 toward the locking position.

According to one embodiment, the camming body 254 includes a pressing finger 258, a stop finger 260, and an opening 262 extending between opposed surfaces of the camming body 254. The pressing finger 258 is configured to interface with one of the metal clamps 250 to apply the prescribed clamping force thereto when the camming body 254 is in the locking position. The stop finger 260 may interface with one of the metal clamps 250 when the camming body 254 is in the unlocking position to prevent further rotation of the camming body 254 relative to the slider 230.

The opening 262 is sized to receive an end portion of the backrest rod 210 and allow for rotating motion of the camming body 254 relative to the backrest rod 210. In this regard, the opening 262 may be slightly elongated (e.g., oval shaped) to accommodate the rotating motion of the camming body 254 relative to the backrest rod 210. The camming body 254 additionally includes a camming surface 264 that interfaces with a sidewall 226 on the carriage 220.

The configurations of the slider bore 248 and the opening 262 of the camming body 254 may be different from each other, and thus, result in different motions of the slider 230 and camming body 254 when the armrest 114 is raised and lowered relative to the backrest rod 210. In particular, the slider bore 248 may be configured to limit motion of the slider in a generally up-and-down motion, whereas the opening 262 of the camming body 254 may result in the camming body 254 rotating relative to the slider 230. This rotation of the camming body 254 relative to the slider 230 may facilitate transition of the camming body 254 between the locking and unlocking positions.

The camming body 254 is configured such that, from the perspective shown in FIG. 17, when the carriage 220 is raised relative to the backrest rod 210, the engagement of the backrest rod 210 to the camming body 254, as well as the interaction between the camming surface 264 and the sidewall 226 causes the camming body 254 to rotate around a pivot screw in a counterclockwise direction from the locking position (as shown in FIG. 17) toward the unlocking position. Conversely, when the carriage 220 is lowered relative to the backrest rod 210, the interaction between the camming surface 264 and the sidewall 226 causes the camming body 254 to rotate around the pivot screw in a clockwise direction.

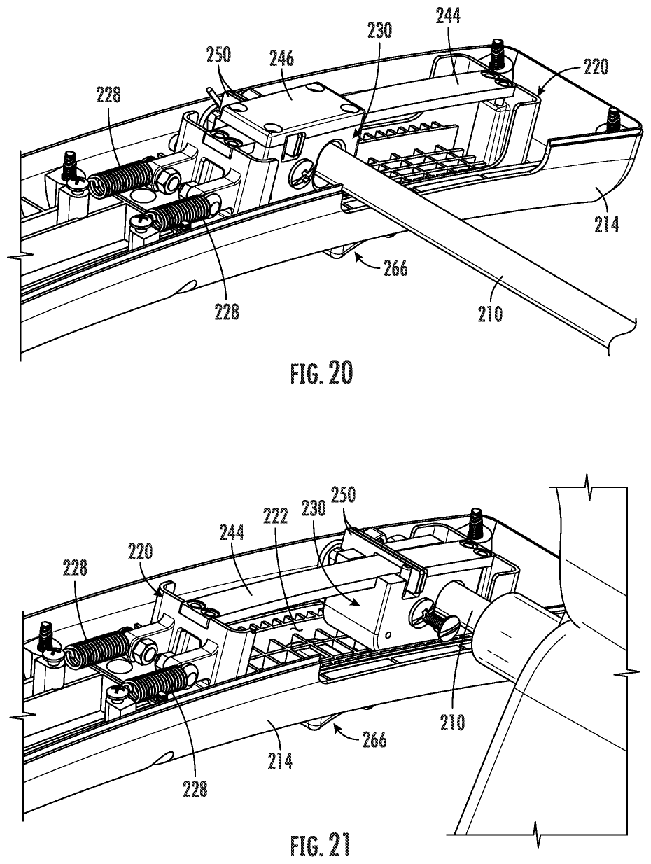

Referring now specifically to FIGS. 20-23, at least one of the armrests 114 may additionally include a toggle switch 266, which is pivotally coupled to the lower body 214 thereof. The toggle switch 266 includes a first end portion 268 and a second end portion 270. The first end portion 268 includes a manual engagement surface and the second end portion 270 includes a locking tab 272. The toggle switch 266 may pivot about an axis located between the first and second end portions 268, 270 and may be pivoted between a locked position and an unlocked position. In the locked position, the locking tab 272 engages with a hole 274, opening or recess formed in the carriage 220 to prevent movement of the carriage 220 within the armrest 114, which in turn prevents rocking of the backrest 104. In the unlocked position, the locking tab 272 is released from the carriage 220, and thus, the carriage 220 may move within the armrest 114 to allow for rocking of the backrest 104. A spring 276 may act on the toggle switch 266 to bias the toggle switch 266 toward the unlocked position.

With the basic structure of the armrest assembly described above, an exemplary use of the armrest assembly, and the related functionality follows below. When the folding chair 100 is opened, a user may sit in the chair and decide to adjust the recline position of the backrest 104. To make the adjustment, the user may reach down under each armrest 114 at the rearward end portions thereof, and slightly pull up on each armrest 114. When the armrests 114 are pulled up, the carriage 220 and slider 230 may be moved upwardly relative to the backrest rod 210, which causes the camming body 254 to move from the locking position toward the unlocking position. As such, the locking force applied by the camming body 254 to the clamps 250 is reduced, which allows the slider 230 to move more freely along the guide rail 244. As the slider 230 is moved along the guide rail 244, the position of the backrest rod 210 relative to the armrest 114 is adjusted. FIGS. 12, 20, and 22 show the slider 230 in a forward-recline position, while FIGS. 13, 21, and 23 show the slider 230 in a rearward-recline position. A user may selectively move the backrest 104 to a more upright position (e.g., forward-recline), or alternatively, to a more reclined position (e.g., rearward-recline). The backrest 104 may be moved to any one of a multiplicity of different positions between a maximum upright position and a maximum recline position. In this regard, the folding chair 100 may not be limited by a fixed number of predefined intermediate positions.

Once the backrest 104 is in the desired position, the user may lower the armrests, 114 which results in a lowering of the slider 230 and carriage 220 relative to the backrest rod 210. As a result, the camming body 254 is moved toward the locking position, and the force applied to the clamps 250 increases, which effectively locks the position of the slider 230 along the guide rail 244. As such, the recline of the backrest 104 is fixed in the desired position.

As the user sits in the chair 100, the user may decide to rock in the chair 100 by leaning back slightly against the backrest 104. The backward lean of the user may cause the backrest rod 210 to move in a slight rearward direction. The interconnection of the backrest rod 210 to the carriage 220, via the intervening slider 230 locked in position relative to the carriage 220, may cause the carriage 220 to move relative to the lower body 214 of the armrest 114 toward the rearward-rock position. As the carriage 220 moves toward the rearward-rock position, the tension in the springs 228 increases, which increases a biasing force on the carriage 220 in a direction toward the forward-rock position. When the magnitude of the biasing force is able to counteract the backward lean of the user, the carriage 220 may reverse course and move toward the forward-rock position. Upon reaching the forward-rock position, the user may lean back again, and start the cycle over. The user may continue to rock within the chair 100 as desired.

It is contemplated that within the chair 100, the backrest rod 210 will be tubular, i.e., define a lumen extending longitudinally therethrough. This lumen is adapted to accommodate wiring as may be used to facilitate the electrical connection to a battery pack as may be integrated into the chair 100 to other features thereof, e.g., a port integrated into one of the armrests 114 and/or heating elements integrated into base and back cushions.

As indicated above, it is contemplated that the folding chair 100 with be outfitted with a battery pack. That battery pack that may be stowed in a pocket disposed on or within a prescribed portion of the folding chair 100, e.g., on the back or rear surface of the backrest 104, on the bottom of the lower support plate 128, etc. The battery pack may provide power to the electrical components on the folding chair 100. The pocket may be formed by a pocket panel extending over a prescribed surface of, e.g., the backrest 104, and may be elasticized, wherein at least a portion of the panel is biased against the adjacent surface to protect against the battery pack inadvertently falling out of the pocket. As also indicated above, the battery pack may be in electrical communication with one or more electrical wires which may be routed to various locations the chair 100 to provide power to the components at those locations. The battery pack may be rechargeable or replaceable with a new battery pack. As such, access to the pocket may enable routing of a power cord for recharging or to remove the battery pack for replacement.

In the event the user does not want the backrest 104 to rock, the user may actuate the toggle switch 266 to prevent rocking of the backrest 104. The hole 274 on the carriage 220 may selectively be brought into alignment with the locking tab 272 on the toggle switch 266. When the user presses the toggle switch 266 toward its locking position, the locking tab 272 will be advanced into the hole 274 on the carriage 220 when the locking tab 272 becomes aligned with the hole 274 on the carriage 220. Such alignment may occur at the approximate halfway point between the maximum upright position and the maximum recline position of the backrest 104. The biasing force imparted by the springs 228 on the carriage 220 may create sufficient friction to maintain the locking tab 272 within the hole 274, until a user desires to transition the toggle switch 266 to the unlocking position to allow the backrest 104 to freely rock. A user may move the toggle switch 266 from the locking position toward the unlocking position by pressing on the second end portion of the toggle switch 266.

It is contemplated that the top end of each of the forward legs 134 may have an elastomeric dampening member integrated therein. Each dampening member is effectively captured between the top end of the corresponding forward leg 306 and the underside of the forward end portion 304 of a respective one of armrests 114. The dampening members function to prevent any undesirable rotational or pivotal movement of the armrests in the absence of the user purposefully pulling up on the same in the aforementioned manner.

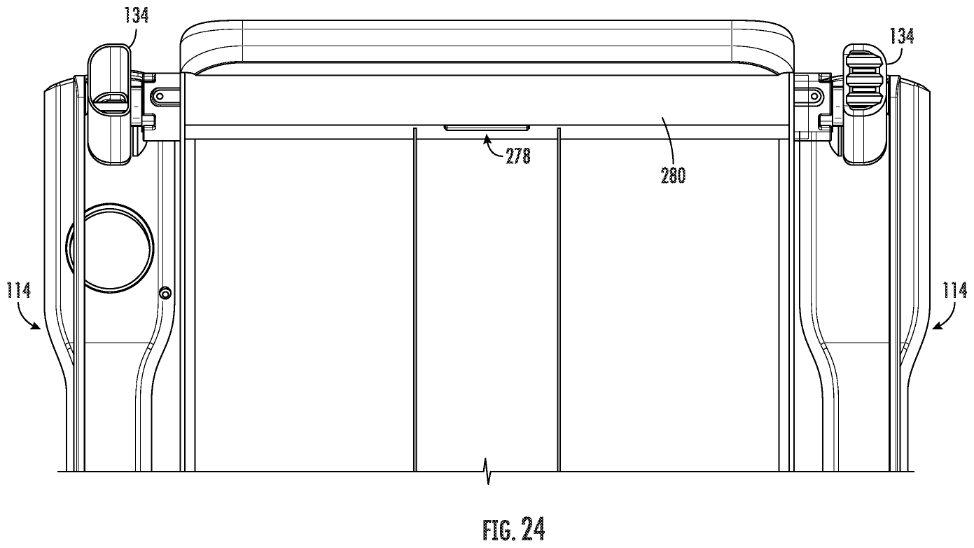

Referring now to FIGS. 24-28, the features related to the folding actuation of the folding chair 100 will be described. The folding actuation may be facilitated by an actuating assembly including a primary body 278 located below the forward end portion of the seat pad and protruding out of a forward support 280. The primary body 278 includes an outer surface 282 and a base surface 284, with a pair of slots 286 being formed in the base surface 284. The slots 286 may be angled relative to each other, such that the ends of the slots 286 adjacent the outer surface 282 are closer to each other than the opposite ends of the slots 286 (e.g., the distance between the slots 286 increases as the distances from the outer surface 282 increases).

The actuating assembly may also include a pair of pivot bodies 288. Each pivot body 288 may include a first segment 290 and a second segment 292 extending at approximate right angles to each other. Each first segment 290 may be pivotally connected to an extension rod 294 and each second segment 292 may be connected to a pin 296 that is received in a respective slot 286 formed on the primary body 278. The interconnection of the primary body 278 to the extension rods 294 through the intervening pivot bodies 288 allows the extension rods 294 to be drawn toward each other in response to moving the primary body 278 from a neutral position to an actuated position, and are moved away from each other as the primary body 278 returns to the neutral position from the actuated position.

Each extension rod 294 is connected to a first locking body 298 that is configured to engage with a corresponding second locking body 300 connected to the forward leg 134. The first locking body 298 includes a distal end portion having several castellations 302 configured to cooperatively engage with correspondingly spaced tabs 304 on the second locking body 300. When the first locking body 298 is engaged with the second locking body 300, the forward leg 134 is locked in position, and when the first locking body 298 is disengaged from the second locking body 300, the forward leg 134 is free to pivot to facilitate folding of the chair 100. The first locking body 298 may be moved in a medial or inward direction to become disengaged from the second locking body 300, and in an opposite lateral or outward direction to become engaged with the second locking body 300.

When the folding chair 100 is open, the first and second locking bodies 298, 300 are engaged with each other to prevent the chair 100 from inadvertently folding. In this regard, the interconnection of the first and second locking bodies 298, 300 prevents the forward legs 134 from pivoting relative to the armrests 114. To close the folding chair 100, a user presses on the primary body 278 of the actuating assembly, which in turn causes the pins 296 to move within the slots 286, with the pins 296 moving toward the outer surface 282 of the primary body 278. Such movement of the pins 296 within the slots 286 draws the pins 296 closer to each other. The extension rods 294, being connected to the pins 296 via the intervening structure of the pivot bodies 288, are also drawn closer together in response to the pins 296 being drawn closer together. As the extension rods 294 are drawn closer together, the first locking bodies 298 are moved away from the second locking bodies 300 (e.g., the first locking bodies 298 are drawn toward a centerline of the chair 100, which may pass through the primary body 278 between the slots 286), which allows the forward legs 134 to pivot relative to the armrests 114.

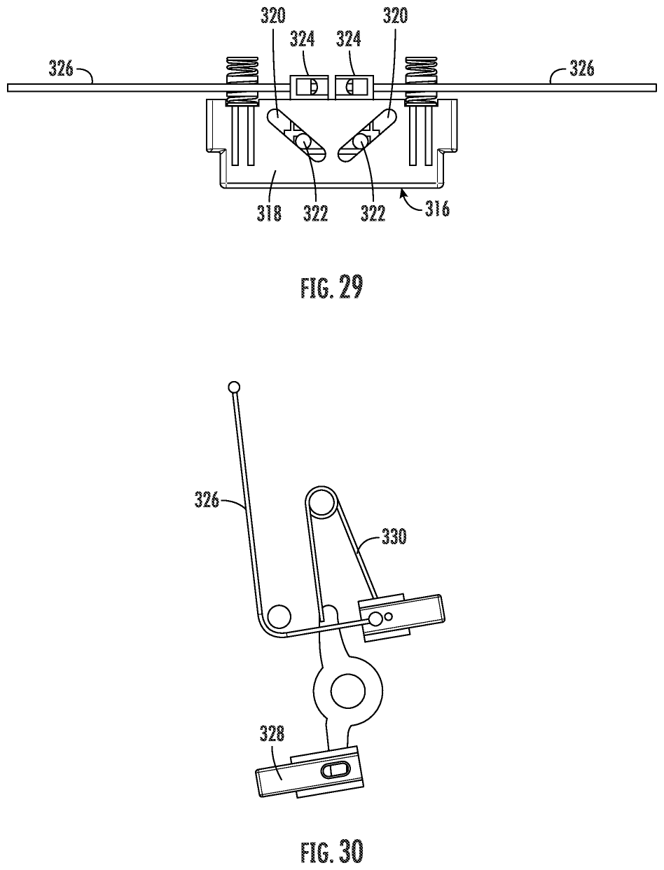

Referring now to FIGS. 29-30, there is shown a mechanism to facilitate the selective extension or retraction of the top portion of the backrest 104, as may be desirable to use the backrest 104 as a handle when pulling the collapsed folding chair 100 on the ground. In this regard, the backrest 104 may comprise an extendable top portion 312 that is slidably engaged with a pair of side tubes 314, such that the top portion 312 may be adjusted between an extended position and a retracted position.

The top portion of the backrest 104 may include a button 316 that may be pressed to unlock the top portion 312 from the side tubes 314 to allow for sliding of the top portion 312 between the extended and retracted positions. The button 316 may include a main body 318 having a pair of angled slots 320, similar to the primary body 278 discussed above. Each slot 320 is engaged with a pin 322, that is connected to a sliding body 324, which is in turn connected to one end of a cable 326. The other end of the cable 326 is operative connected to a lock body 328. A plurality of lock apertures may be formed in the side tubes 314 of the backrest 104, with each lock body 328 being receivable within a respective lock aperture to restrict extension or retraction of the top portion 312 relative to the side tubes 314. Thus, movement of the top portion 312 may only be achieved when each lock body 328 has been retracted from the lock apertures. The side tubes 314 of the backrest 104 may include a number of spaced, linearly aligned lock apertures at various heights, which correspond to varying degrees of extension of the top portion 312.

When the main body 318 is pressed inwardly by a user, the sliding bodies 324 are moved toward each other as the pins 322 move within their respective slots 320. Such movement of the sliding bodies 324 pulls on the cables 326, which in turn, pulls the lock bodies 328 out of their lock aperture to allow for extension or retraction of the top portion 312. The user may release the button 316, and a spring 330 may bias the lock body 328 in the direction of engagement with a lock aperture, such that when the lock body 328 is aligned with a lock aperture at the desired position of the top portion 312, the lock body 328 may be advanced into the lock aperture to lock the top portion 312 in place.

The particulars shown herein are by way of example only for purposes of illustrative discussion and are not presented in the cause of providing what is believed to be most useful and readily understood description of the principles and conceptual aspects of the various embodiments of the present disclosure. In this regard, no attempt is made to show any more detail than is necessary for a fundamental understanding of the different features of the various embodiments, the description taken with the drawings making apparent to those skilled in the art how these may be implemented in practice.

### APPENDIX—MATERIAL INCORPORATED BY REFERENCE

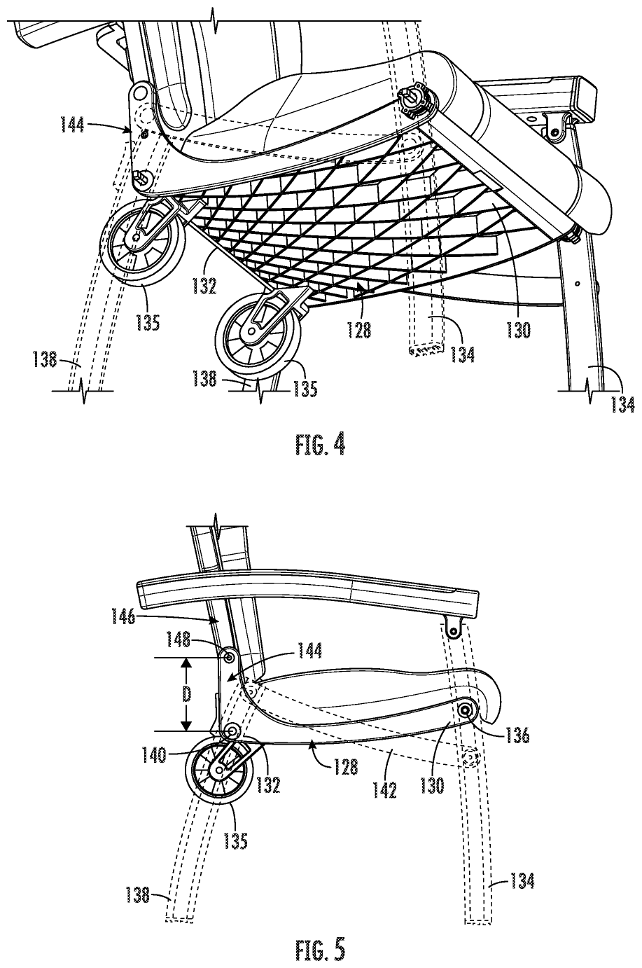

The disclosure below is reproduced from U.S. Provisional Application No. 63/081,510 filed Sep. 22, 2020, indicated above to be incorporated by reference. This connect is being provided only to avoid potential issues that could arise in relation to any later attempts to incorporate this disclosure by reference in jurisdictions outside of the United States. Accordingly, it should be noted that the figure descriptions and reference numbers set forth in the following paragraphs will not conform to FIGS. 1-30 identified above, or the references numbers included therein as identified in the previous passages of the Detailed Description.

Referring now to the drawings, wherein the showings are for purposes of illustrating preferred implementations of the present disclosure, and are not for purposes of limiting the same, there is depicted a folding chair 10 having several attributes which enhance the overall comfort and ease of use of the folding chair 10. In this regard, as will be described in more detail below, the folding chair 10 may be specifically configured and adapted to allow for quick and easy transition between a folded configuration and a deployed configuration, while at the same time, enhancing the overall comfort for the individual seated within the folding chair 10. Furthermore, the folding chair 10 may incorporate one or more accessories or added features aimed at further enriching the experience of an individual seated in the folding chair 10.

FIG. 1 is an upper perspective view of one embodiment of the folding chair 10, with various features being labeled and which will be discussed in more detail below. According to one embodiment, the ability of the folding chair 10 to transition between the folded configuration and the deployed configuration is attributable to an articulating support frame assembly 12. Pads 14, 16, 18 may be connected to the support frame assembly 12 to improve the overall comfort of the folding chair 10. FIGS. 2-5 show the support frame assembly 12 in the deployed configuration with the pads 14, 16, 18 having been removed from the support frame assembly 12, while FIGS. 6-9 show the folding chair 10 in the deployed configuration with the pads 14, 16, 18 attached to the support frame assembly 12.

The support frame assembly 12 may generally include an upper back subframe 20, a lower back subframe 22, a pair of armrests 24, and a plurality of legs 26, 28. The upper back subframe 20 includes a pair of elongate side members 30 and an upper member 32 extending between the elongate side members 30. Each elongate side member 30 includes an upper end portion and a lower end portion. The upper member 32 extends transversely relative to the elongate side members 30 adjacent the upper end portions thereof. In one embodiment, the upper member 32, or at least a portion thereof, may be moveable relative to the pair of side members 30 along an axis generally parallel to the side members to allow the upper member 32 to function as a handle when pulling the folding chair 10, as will be described in more detail below.

The upper back subframe 20 is pivotally coupled to the lower back subframe 22 to collectively define a backrest 23 of the folding chair 10. The lower back subframe 22 may comprise a pair of side members 34, and a pair of transverse members 36 extending between the pair of side members 34. The side members 34 of the lower back subframe 22 may be pivotally coupled to the side members 30 of the upper back subframe 20 to allow for pivotal movement therebetween about an axis 35 generally colinear with the upper one of the transverse members 36 of the lower back subframe 22.

A pair of wheels 38 may be connected to the lower back subframe 22 adjacent the intersection of the side members 34 with the lower one of the transverse members 36. Referring to FIG. 10, each wheel 38 may be connected to a fork 40, which is in turn, connected to the lower back subframe 22. A pin may be used to connect the wheel 38 to the fork 40, with the wheel 38 being rotatable about the pin, and thus, the pin defining a rotational axis about which the wheel 38 may rotate. The wheels 38 are configured to be spaced above the ground when the folding chair 10 is in the deployed configuration and roll on the ground to ease transport of the folding chair 10 when the folding chair 10 is in the folded configuration, as will be described in more detail below.

The armrests 24 are connected to at least one of the upper back subframe 20 and the lower back subframe 22. In the exemplary embodiment, each armrest 24 includes an armrest rod 42 pivotally coupled to a corresponding side member 30 of the upper back subframe 20 such that the armrest rod 42 is pivotable about axis 35, and such that the side member 30 of the upper back subframe 20 is positioned between the armrest rod 42 and the side member 34 of the lower back subframe 22 (see FIG. 3). An armrest cover 44 of each armrest 24 may be positioned over the corresponding armrest rod 42. The armrest covers 44 each define an upper surface; those upper surfaces being adapted for a user to rest their arms when seated in the folding chair 10. In this regard, the upper surfaces may be padded for comfort.

According to one embodiment, and referring now specifically to FIGS. 11 and 12, the armrests 24 may be specifically configured and adapted to facilitate a dampened rocking motion for the backrest 23 when the folding chair 10 is in the deployed configuration. It is noted that FIGS. 11 and 12 show the armrest cover in phantom to more clearly illustrate the internal components, which will be described in more detail herein.

Each armrest rod 42 may include a main body 46 and an enlarged head 48. Each armrest 24 may further include a bracket 50 moveably coupled to a corresponding armrest rod 42. Each bracket 50 may include a rear plate 52, a forward plate 54, and a middle plate 56 extending between the rear plate 52 and the forward plate 54. The rear plate 52 may include a slot or opening which allows the main body 46 of the armrest rod 42 to extend therethrough, and the forward plate 54 may be connected to at least one, and preferably an opposed pair of adjustment tabs 58, which may extend through respective slots 60 formed in the armrest cover 44. The bracket 50 may be connected to the armrest rod 42 such that the enlarged head 48 is positioned between the rear plate 52 and the forward plate 54. A coil spring 62 may be captured between the enlarged head 48 and the rear plate 52 to operatively interface the armrest rod 42 to the bracket 50.

A user may selectively adjust an incline of the backrest 23 by adjusting the position of the tabs 58 within the slots 60 formed in the armrest cover 44. The armrest cover 44 and the tabs 58 may be configured to allow the tabs 58 to be selectively positioned in any one of a number of different preselected positions along the slot 60. In this regard, the tabs 58 and armrest cover 44 may include complementary detents/grooves or other locking structures which will allow each tab 58 to be maintained in the desired position along the slot 60 until acted upon by the user. The adjustment may be performed substantially simultaneously to all tabs 58 on each armrest 24 to adjust both sides of the backrest 23 and to prevent undesirable torqueing or twisting of the backrest 23. As the tabs 58 are moved forward, the bracket 50 moves forward, which in turn, causes the armrest rod 42 to move forward. In particular, the rear plate 52 of the bracket 50 pushes the spring 62, which in turn, pushes the enlarged head 48 to move the armrest rod 42 forward. As the tabs 58 are moved from a forward position toward a rearward position, the bracket 50 moves rearward. As the bracket 50 is moved in a rearward direction, the weight of the backrest 23 imparts a rearward force on the armrest rod 42 and causes the armrest rod 42 to move rearwardly in concert with the bracket 50.

The spring 62 captured between the armrest rod 42 and the bracket 50 may allow for dampened rocking of the backrest 23 relative to the lower subframe of the folding chair 10. In particular, when a user is seated in the folding chair 10 and leans back, the backrest 23 is moved rearwardly. The interconnection between the backrest 23 and the armrest rod 42 causes the armrest rod 42 to move rearwardly with the backrest 23. The rearward movement of the armrest rod 42 compresses the spring 62 between the enlarged head 48, which moves with the backrest 23, and the rear plate 52 of the bracket 50, which remains stationary. As the distance between the enlarged head 48 and the rear plate 52 decreases, the spring 62 is compressed, the spring 62 imparts a dampening force on the armrest rod 42, which prevents the backrest 23 from coming to an abrupt stop.

When the user leans forward, the spring 62 applies a force on the enlarged head 48, which urges the armrest rod 42 forward, which in turn, urges the backrest 23 to its forward, natural position. In this regard, the spring 62 causes the backrest 23 to automatically return to its forward, neutral position whenever the user stops leaning back or stands up from being seated in the folding chair 10.

The folding chair 10 includes a pair or rear legs 28 pivotally coupled to opposed sides of the lower back subframe 22 and a pair of front legs 26 pivotally coupled to respective ones of the armrests 24, and in particular, the armrest covers 44. Each rear leg 28 includes a forward edge 64, and each front leg 26 includes a rearward edge 66. A rear leg angle Θ1 is defined between each forward edge 64 and the lower portion of the backrest 23 (e.g., the lower back subframe 22), and a front leg angle Θ2 is defined between each rearward edge 66 and the corresponding armrest 24. The rear leg angles Θ1 and front leg angles Θ2 on the folding chair 10 may vary as the folding chair 10 is transitioned between the deployed and folded configuration, as will be explained in more detail below.

A front support bar 68 extends between the pair of front legs 26 to provide a rigid, forward structural member to which the lower seat pad 18 may be attached. Each corresponding pair of the rear legs 28 and front legs 26 are coupled to each other via side linkages 70, 72, i.e., each rear leg 28 is connected to a corresponding front leg 26 via a respective pair of side linkages 70, 72. Each side linkage 70, 72 is pivotally connected to a respective front leg 26 at one end portion and the corresponding rear leg 28 at an opposing end portion. Thus, each pair of the side linkages 70, 72 may be arranged to form a shallow “X” configuration when the folding chair 10 is in the deployed configuration. In this regard, the side linkages 70, 72 may be connected to the front leg 26 such that the end portion of a first linkage 70 is above the end portion of a second linkage 72 and connected to the rear leg 28 such that the end portion of the first linkage 70 is below the end portion of the second linkage 72.

As noted above, the folding chair 10 may include a plurality of pads 14, 16, 18 coupled to the support frame assembly 12 for enhancing the comfort of the folding chair 10. In the exemplary embodiment, folding chair 10 includes upper back pad 14, a lower back pad 16, and a lower seat pad 18. The upper back pad 14 is coupled to the upper back subframe 20, the lower back pad 16 is coupled to the lower back subframe 22, and the lower seat pad 18 may be coupled to the front support bar 68 and at least one side linkage 70, 72 on either side of the lower seat pad 18. The padding used on the folding chair 10 may be specifically configured and adapted so as to minimize interference with the folding chair 10 transitioning to the folded configuration. For instance, the upper back pad 14 may be moveable relative to the lower back pad 16 during the transition between the deployed and folded configurations.

With reference now specifically to FIGS. 13-21, the action of transitioning the folding chair 10 between the deployed configuration and the folded configuration will be described. FIG. 13 shows the folding chair 10 in the deployed configuration. In the deployed configuration, distal end surfaces defined by the legs 26, 28 are generally co-planar to allow the folding chair 10 to be supported on an underlying support surface. Furthermore, in the deployed configuration, the folding chair 10 defines a seating surface that is generally horizontal, and a back-support surface that is generally upright.

Referring now specifically to FIG. 14, the folding chair 10 depicted therein has begun the transition from the deployed configuration shown in FIG. 13 toward a folded configuration. In this regard, the front legs 26 have been pivoted toward the armrest 24 about an axis defined by the front support bar 68 such that the front leg angle Θ2 therebetween becomes smaller. This motion also brings the front legs 26 toward the rear legs 28. Furthermore, the rear legs 28 have been pivoted in a forward direction, toward the rear legs 28 in a manner which results in the rear leg angle Θ1 becoming smaller. The initial movement of the folding chair 10 from the deployed configuration toward the folded configuration may cause the armrest covers 44 to move away from the backrest 23. In particular, the pivotal movement of the front legs 26 may cause the upper portion of the front legs 26 to move forwardly, e.g., away from the backrest 23, and the lower portion of the front legs 26 to move rearwardly, e.g., toward the backrest 23. The interconnection between the upper portion of the front legs 26 to the armrest covers 44 may pull the armrest covers 44 away from the backrest 23, which compresses the spring 62 located within each armrest 24 and exposes more of the armrest rod 42.

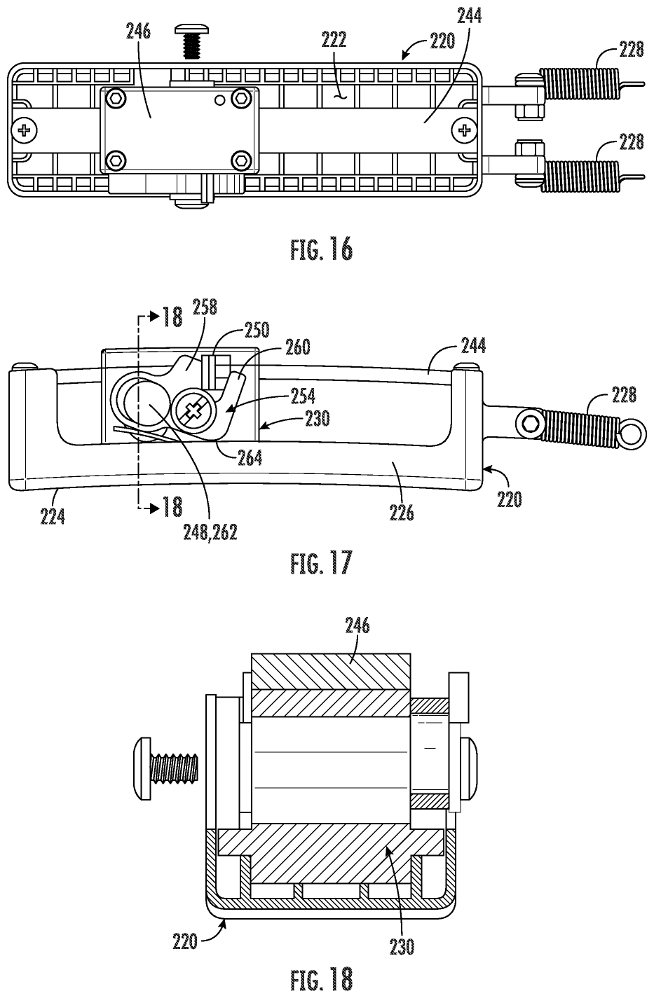

The sequence continues in FIGS. 15 and 16, with the magnitude of the front leg angles Θ2 and the rear leg angles Θ1 further decreasing, and the armrest cover 44 continuing to move away from the backrest 23, which further compresses the spring 62 and increases the force exerted by the spring 62 on the armrest rod 42 to bias the armrest rod 42 in the forward direction. The increasing force exerted by the spring 62 may act on the upper back subframe 20, via the armrest rod 42, to pull the upper back subframe 20 in a forward direction. In FIG. 17, the upper back subframe 20 has been pivoted relative to the lower back subframe 22 in a forward direction, which moves the upper back pad 14 toward the lower seat pad 18.

FIG. 18 shows the upper back subframe 20 continuing in a forward direction.

The upper back subframe 20 and lower back subframe 22 may be connected in a manner which allows for a limited amount of forward pivotal movement of the upper back subframe 20 relative to the lower back subframe 22. Thus, once the upper back subframe 20 has reached the maximum amount of forward pivotal movement relative to the lower back subframe 22, the lower back subframe 22 may pivot forwardly with the upper back subframe 20, as shown in FIGS. 18-21, until the upper back pad 14 and lower back pad 16 rest lie against the lower seat pad 18. Along these lines, as is apparent from these FIGS. 18-21, even when the folding chair 10 is in its fully collapsed or folded configuration, there is some measure of angular offset between the lower back pad 16 and each of the upper back pad 14 and lower seat pad 18 which extend in generally parallel relation to each other. This offset, attributable to the construction of the support frame assembly 12 and its preferred manner of articulation between the deployed and folded configurations, is particularly suited to accommodate increased thicknesses of the various pads 14, 16, 18 while not comprising or otherwise unduly interfering with the ability to collapse the support frame assembly 12. As will be recognized, these increased pad thicknesses enhance the seating comfort provided by the folding chair 10.

As the upper back subframe 20 continues in a forward, downward motion, the armrest rod 42 retreats back into the armrest cover 44. The angle between the armrest rod 42 and the upper back subframe 20 also decreases. Along these lines, the upper back subframe 20 may return to a generally coplanar position relative to the armrest rods 42, or even extend beyond the armrest rods 42.

While the backrest 23 is moving toward the lower seat pad 18, the legs 26, 28 continue collapsing until the front legs 26 are positioned in generally overlapping arrangement with the rear legs 28. In the folded configuration, the front leg angles Θ2 and the rear leg angles Θ1 may be at a minimum. The side linkages 70, 72 also collapse such that when the folding chair 10 is in the folded configuration, the side linkages 70, 72 may overlap with the collapsed front and rear legs 28. In this regard, transitioning the folding chair 10 from the deployed configuration toward the folded configuration causes the side linkages 70, 72 on a given side of the folding chair 10 to transition from an intersecting, X-shaped configuration, into a configuration wherein the side linkages 70, 72 are generally parallel to each other.

Transition of the folding chair 10 from the deployed configuration to the folded configuration also causes the wheels 38 to assume a position which is favorable for rolling the folding chair 10 on the ground or other support surface. In this regard, the wheels 38 may extend beyond the distal, terminal ends of the rear legs 28 to form a distal most end portion of the folding chair 10 when the folding chair 10 is in the folded configuration. When the folding chair 10 is in the deployed configuration and the chair 10 is supported by the legs 26, 28, the wheels 38 are spaced from the ground surface.

Transport of the folding chair 10 further be facilitated through an integrated, selectively deployable handle. Referring now to FIG. 22, there is depicted three separate embodiments of handles that may be incorporated into the folding chair 10. In image 1, handle 74a is integrated into a deployable panel 76 which is extendable from the upper back subframe 20. The deployable panel 76 may also function as a headrest when the folding chair 10 is in the deployed configuration. Image 2 shows handle 74b defined by the upper transverse member 32 of the upper back subframe 20, which is connected to the adjacent side members 30 via side extensions 78. These side extension 78 are received within openings or channels formed in the corresponding side members 30. Image 3 shows a telescoping handle 74c having an extension arm 80 advanceable into a central collar 82 coupled to the upper back subframe 20. It is contemplated that other handle configurations may also be used without departing from the spirit and scope of the present disclosure. For instance, the handle may include a strap or band that is connected to the upper back subframe 20.

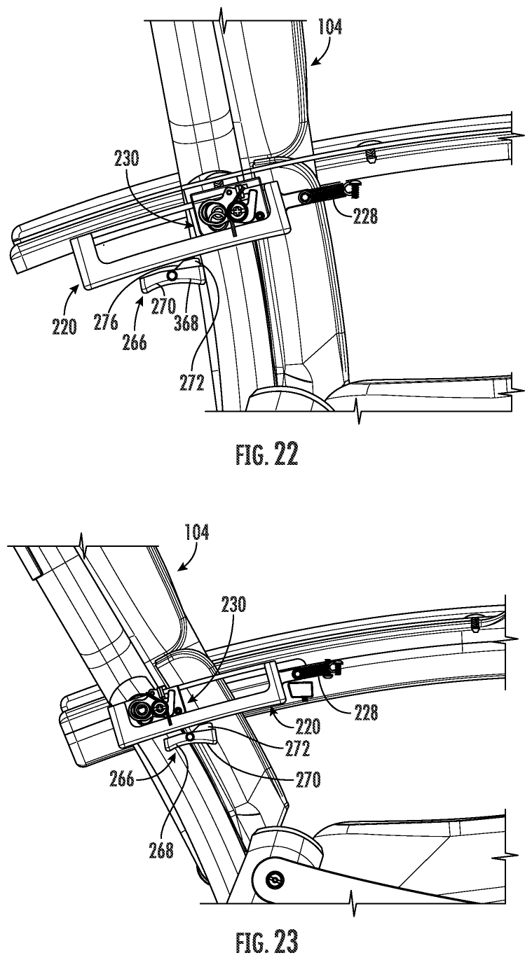

Referring now to FIGS. 23 and 24, it is contemplated that the folding chair 10 may be configured to allow multiple folding chairs 10 to be connected or stacked together to allow multiple folding chairs 10 to be collectively transported. As shown in FIG. 23, each folding chair 10 may include a hook or bracket 84 which is sized and positioned to be engageable with a portion of an adjacent folding chair 10. In particular, the bracket 84 is positioned opposite the seating surface of the lower seat pad 18, and between the front support bar 68 and the lower back subframe 22. The bracket 84 may be configured to engage with a portion of the backrest 23, such as one of the transverse members 36 of the lower back subframe 22 on the adjacent folding chair 10. When the adjacent folding chairs 10 are connected, they may be arranged in the configuration shown in FIG. 24. In this regard, the ability to interconnect several folding chairs 10 allows a single individual to transport multiple chairs 10. Thus, if a family is using several chairs at an outdoor event, a single person may transport the chairs for the entire family to a vehicle or other location.

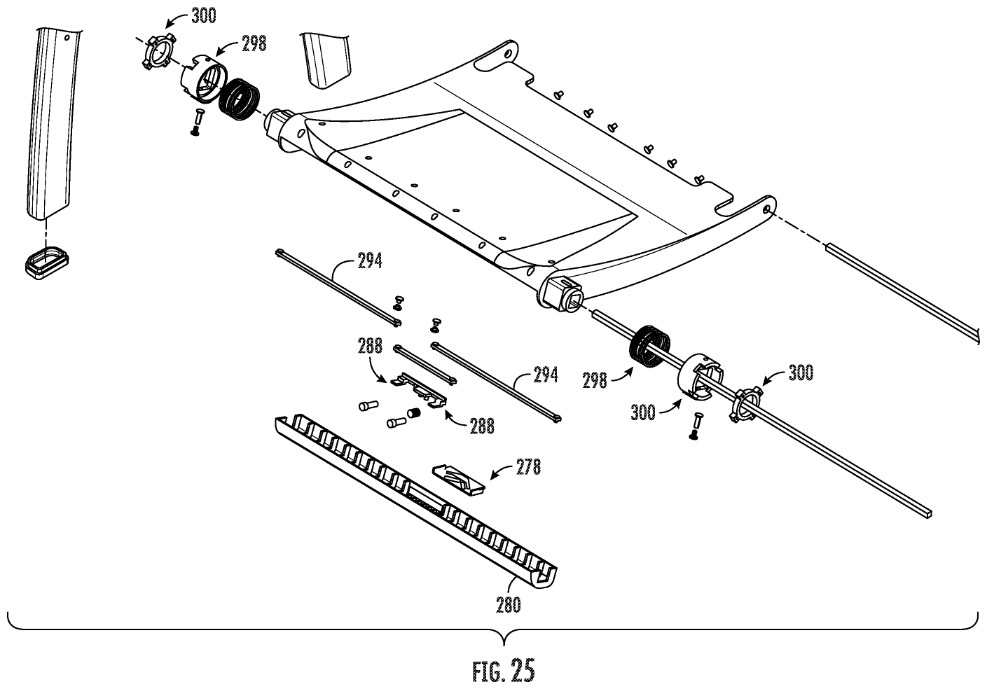

It is contemplated that the folding chair 10 may have several accessories integrated therein to enhance the overall functionality thereof. Along those lines, and referring to FIG. 25, which is a reproduction of the folding chair 10 depicted in FIG. 1, in one embodiment, the folding chair 10 may include a battery 86 integrated therein to provide power to electrically powered accessories on the folding chair 10, such as electrical blankets, lights, speakers, or to provide power to electrical items which may be used by an individual seated in the chair 10, such as a smartphone or tablet computer. FIG. 25 shows a first embodiment of the battery 86 and its operative connection to an armrest 24 of the folding chair 10. The battery 86 may be removably connected to the armrest 24 and includes a cylindrical shaft 88 insertable into a corresponding cylindrical opening on the armrest 24. The battery 86 may also include a head 90 coupled to the cylindrical shaft 88, with the head 90 being similar in shape to that of the armrest 24, so as to form an extension of the armrest 24 when the battery 86 is inserted into the armrest 24. The battery 86 may be removed from the armrest 24 for charging or to allow for replacement of a replacement battery 86. It is contemplated that the folding chair 10 may incorporate solar charging panels to allow for charging of the battery 86.

One or more charging ports 92, e.g., USB or micro USB, may be integrated into the battery 86 (e.g., into the head 90), or integrated into other portions of the folding chair 10 and operatively connectable to the battery 86. The charging ports 92 may allow for charging of smartphones, tablet computers, speakers, electronic readers, or other electronic devices that may be used by an individual seating in the chair 10. It is also contemplated that the battery 86 may be operatively connectable to a Qi wireless induction charger for compatible smartphones. It is also contemplated that the battery 86 may have a shape or profile differing from that shown in FIG. 25. By way of example and not by way of limitation, the generally cylindrical shaft 88 may be substituted with a generally quadrangular extension which protrudes from the head 90, such as that shown in FIGS. 11 and 12. In this regard, irrespective of the shape of that portion of the battery 86 which is intended to be advanced into and normally reside within the armrest cover 44 of a corresponding armrest 42, it is contemplated that such shape and its overall dimensions will allow for such advancement with interfering with the associated dampening mechanism.

FIG. 25 also shows a first embodiment of a cupholder 94 integrated into the armrest 24. The cupholder 94 may be collapsible to minimize interference with other portions of the folding chair 10 as the folding chair 10 transitions between the deployed and folded configurations. The cupholder 94 may include a rigid frame 96 integrated into the armrest cover 44, and a collapsible body 98 coupled to the frame 96. The collapsible body 98 may assume a stowed position wherein a terminal end portion thereof is moved toward the frame 96 or a deployed position, wherein the terminal end portion thereof is moved away from the frame 96. The transition of the collapsible body 98 between the stowed and deployed positions may be facilitated through a foldable sidewall, a series of interconnected and telescopically arranged sidewalls, via a hinge, or via other modalities known in the art.

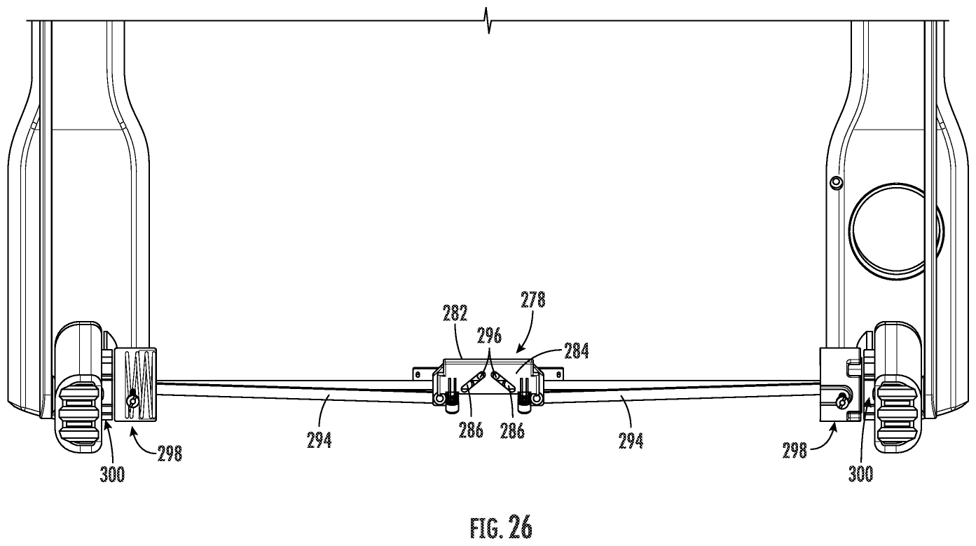

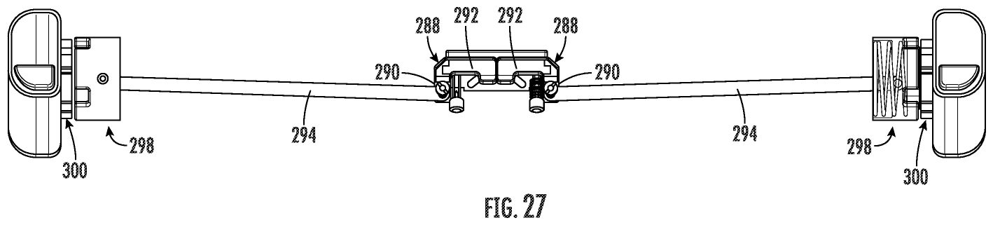

Referring now to FIGS. 26 and 27, it is contemplated that various embodiments of the folding chair 10 may include one or more blankets and/or foot warmers operatively coupled thereto. FIG. 26 shows a sequence of images related to deployment of a foot warmer 100, as well as deployment of a blanket 102. The foot warmer 100 may be rolled up and stowed in a lower, front portion of the lower seat pad 18. To deploy the foot warmer 100, a user removes the foot warmer 100 from its storage space in the pad 18, unrolls it, and thereafter unfolds it, as indicated by the arrows in FIG. 26. The re-storage of the foot warmer 100 is facilitated using a reverse sequence of steps. When deployed, the foot warmer 100 may include a sack 104 coupled to a tether 106 attached to the lower seat pad 18, within which the user may place his or her feet and lower legs for warmth or to protect against natural elements, such as the sun, wind or rain. The foot warmer 100 may include a drawstring 108 to allow for cinching of the upper end portion of the foot warmer 100 around the user's legs when inserted into the footwarmer 100.

The blanket 102 may be attached to a tether 110 coupled to the lower seat pad 18 and may be folded and stored in a front crease or pocket formed in the lower seat pad 18. The blanket 102 may be sized to extend over the upper legs of the user. Thus, the blanket 102 and foot warmer 100 may collectively substantially cover the user's legs when both are deployed, and the user is seated in the folding chair 10. It is completed that the blanket 102 and/or the foot warmer may be heated, i.e., be outfitted with heating elements similar to conventional heating blankets. The heating elements may be placed into electrical communication with the battery 86 via suitable connection modalities which pass through the tether 106 and/or tether 110.

Referring now to FIG. 27, there is shown another embodiment of a foot warmer 112 incorporated into the lower seat pad 18. In the embodiment shown in FIG. 26, the lower seat pad 18 includes a pouch 114, which may be unfolded to uncover the foot warmer 112. Like the foot warmer 100, the foot warmer 112 may also be outfitted with heating elements electrically coupled to the battery 86.

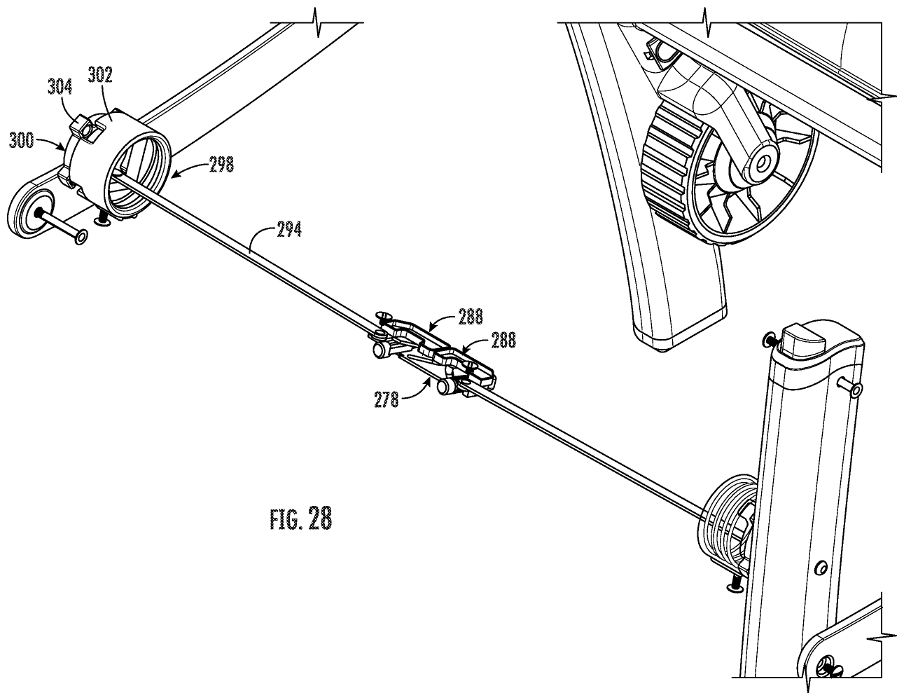

Referring now to FIG. 28, there is depicted a series of ponchos 116 or covers specifically configured and adapted to extend over an individual seated in the chair 10. Each poncho 116 includes a head opening 118 formed therein and is sized to drape over the individual and portions of the folding chair 10 to protect the individual seated in the chair 10 from the nature elements. The poncho 116 may include a lower edge having an elastic band or a drawstring associated therewith to allow the lower edge to cinch around the user and foldable chair 10. Like the foot warmer 100, 112 and/or blanket 102, the poncho 116 may also include an optionally integrated heating element, which may be operatively coupled to the battery 86 to provide power thereto.

Referring now to FIGS. 29 and 30, it is contemplated that one or more embodiments of the folding chair 10 may include a selectively deployable sun shade 120. The sun shade 120 may include a panel 122, and an arm 124 extendable from the upper back pad 14 or seat frame. The panel 122 may be detachably connected to the arm 124 to provide shade to the individual seated within the folding chair 10. The position of the arm 124 relative to the upper back pad 14 may be adjustable to allow for adjustment of the sun shade 120.

As shown in FIG. 29, the panel 122 may be foldable and stowable in a seatback pocket 126. The panel 122 may include a wireframe that is spring biased toward an unfolded position to expedite deployment of the sun shade 120. FIG. 29 shows one embodiment, where the panel 122 may be connected to a pair of arms 124 extending upwardly, or from a common side to adjust the shade cast by the panel 122.

FIG. 30 shows another embodiment of the sun shade 128, again, including a panel 130 and an arm 132. However, the panel 130 may include a foldable frame incorporating one or more hinges 134 to facilitate the folding motion. Furthermore, the arm 132 includes a hub 136 rotatable coupled to the upper back pad 14 and includes a first arm rod 138 extending from the hub 136, and a second arm rod 140 coupled to the first arm rod 138 via an arm hinge. The rotational connection of the hub 136 and the pivotal connection between the first and second arm rods 138, 140 allow for adjustment of the shade cast by the panel 130.

FIGS. 31-38 depict another embodiment of the folding chair 200. The folding chair 200 depicted in FIGS. 31-38 includes several features in common with the foregoing disclosure, and thus, the following discussion will focus on those features that are unique to the embodiment depicted in FIGS. 31-38.

FIG. 31 shows the folding chair 200 in a folded configuration, while FIGS. 32-38 show the folding chair 200 in a deployed configuration. The folding chair 200 includes a support frame assembly generally including a primary back subframe 202, a secondary back subframe 204, a pair of armrests 206, and a plurality of legs 208. The primary back subframe 202 includes a pair of side members 210, and a lower member 212 extending between the pair of side members 210. The side members 210 may extend away from the lower member 212 and include a lower portion, a transition portion, and an upper portion terminating at an upper end 214. The lower portion may be positioned more inward (e.g., closer to the middle of the chair) than the upper portion. The inward positioning of the lower portion may be to provide space for the secondary back subframe 204 between the lower portion and the armrests 206.

The primary back subframe 202 may further include an upper member 216 having a top bar 218 and a pair of side bars 220. The side members 210 may be hollow, so as to facilitate slidable engagement with the side bars 220 of the upper member 216. The top bar 218 may function as the top structural support member of the primary back subframe 202, particularly when the chair 200 is in the deployed configuration. The top bar 218 may also function as a handle or gripping surface for a user to facilitate transport of the chair 200. In this regard, the upper member 216 may be telescopically connected to the side members 210 to allow the upper member 216 to be extended outwardly when used as a handle and retracted when not used as a handle. When the upper member 216 is extended outwardly, the length of the exposed portion of the side bars 220 extending from the upper end 214 of the side members 210 increases, and when the upper member 216 is retracted, the length of the exposed portion of the side bars 220 extending from the upper end 214 of the side members 210 decreases.

The secondary back subframe 204 includes a pair of side members 222 and a lower member 224 extending between the pair of side members 222. The pair of side members 222 on the secondary back subframe 204 are pivotally connected to respective ones of the pair of side members 210 on the primary back subframe 202. The pivotal motion of the secondary back subframe 204 relative to the primary back subframe 202 may occur as the chair 200 is transitioned between the folded configuration and the deployed configuration. FIG. 31 shows the chair 200 in the folded configuration, wherein the side members 222 on the secondary back subframe 204 are angled relative to the side members 210 on the primary back subframe 202. As can be seen in FIG. 33, when the chair 200 transitions from the folded configuration to the deployed configuration, the side members 222 on the secondary back subframe 204 are generally parallel to the side members 210 on the primary back subframe 202. A pair of stop tabs 226 may be connected to the primary back subframe 202 and extend from respective side members 210 thereof to provide an abutment or physical stop which may contact the secondary back subframe 204 when the side members 222 of the secondary back subframe 204 are generally parallel to the side members 201 on the primary back subframe 202.

Referring now specifically to FIG. 31, the folding chair 200 may include a battery pack 228 that may be stowed in a pocket 230 and which may provide power to the electrical components on the folding chair 200. The pocket 230 may be formed by a pocket panel 232 extending over a rear surface of a backrest pad 234. The pocket panel 232 may be elasticized, wherein at least a portion of the panel 232 is biased against the backrest pad 234 to protect against the battery pack 228 inadvertently falling out of the pocket 230. The battery pack 228 may be in electrical communication with one or more electrical wires which may be routed to various locations the chair 200 to provide power to the components at those locations. The battery pack 228 may be rechargeable or replaceable with a new battery pack 228. As such, access to the pocket 230 may enable routing of a power cord for recharging or to remove the battery pack 228 for replacement.

One particular electrical component which may receive power from the battery pack 228 may be a wireless charging pad 236 integrated into one or both of the armrests 206. The wireless charging pad 236 may allow for wireless charging of smartphone, tablet computers or other compatible electronic devices.

The battery pack 228 may also provide power to any electrically heated blanket or footwarmer associated with the chair 200, as well as to any USB port 238 located on the folding chair 200. For instance, the forward end face of one or more of the armrests 206 may include a USB port 238 integrated therein to allow for electrical connection with remote electronic components. Those of ordinary skill in the art will recognize that in the folding chair 200, the battery pack 228 is provided in substitution for the above-described battery 86 integrated into the armrest 24 of the folding chair 10. However, it is contemplated that the armrests 206 of the folding chair 200 will nonetheless each still be outfitted with those rocking motion dampening modalities also described above.

Referring now to FIGS. 39-64, there is depicted another embodiment of a folding chair 300 that includes features related to selective incrementally adjusted backrest recline, backrest rocking, folding actuation, compact folding and handle extension that differ from the embodiments described above. In this regard, many of the remaining features of the folding chair 300 are similar to that described above, and thus, the following discussion focuses on the features that are unique to the folding chair 300.

The folding chair 300 includes a pair of armrests 302, each armrest 302 including a forward end portion 304 pivotally connected to a respective forward leg 306, and a rearward end portion 308 connected to a backrest rod 310 that extends between opposed portions of a backrest frame 311. Each armrest 302 is configured to be slightly raised and lowered from the rearward end portion 308 relative to seat portion 313 to allow for selective recline adjustment of the backrest 312. Along these lines, FIGS. 39 and 41 show the backrest 312 in an upright position, while FIGS. 40 and 42 show the backrest 312 in a recline position. FIG. 43 shows the folding chair 300 in the completely folded or collapsed configuration.

Referring now to FIGS. 44-55, each armrest 302 includes a lower body 314 and an upper body 316, which may be connected to each other to collectively define an armrest cavity 318 therein. The armrest 302 may include an internal assembly 319 connected to the backrest rod 310, with the internal assembly 319 being moveable within the armrest cavity 318 to facilitate recline adjustment, as well as to enable rocking of the backrest 312. FIG. 44 shows the internal assembly 319 in a forward position, while FIG. 45 shows the internal assembly 319 in a rearward position.

According to one embodiment, the internal assembly 319 includes a carriage 320 located within the armrest cavity 318 and moveable relative to the lower and upper bodies 314, 316, with such movement allowing for rocking of the backrest 312, as will be described in more detail below. The carriage 320 includes a cavity 322 collectively defined by a lower wall 324 and a plurality of sidewalls 326. The carriage cavity 322 may be open at the top. The carriage 320 may be coupled to one of the lower and upper bodies 314, 316 of the armrest 320 via one or more springs 328, which apply a dampening force to the carriage 320 as the carriage 320 moves from a forward-rock position to a rearward-rock position. In particular, the springs 328 may elongate as the carriage 320 moves from the forward-rock position toward the rearward-rock position, and recoil as the carriage 320 moves from the rearward-rock position toward the forward-rock position.

A slider 330 may be located within the carriage cavity 322 and may be translatable within the carriage cavity 322 between a forward-recline position and a rearward-recline position to facilitate selective, incremental recline adjustment of the backrest 312. The slider 330 includes a top surface 332, a bottom surface 334, a forward surface 336, a rearward surface 338, and a pair of opposed side surfaces 340. The slider 330 further includes a guide slot 342 extending between the forward and rearward surfaces 336, 338, In the exemplary embodiment, the guide slot 342 extends into the slider 330 from the top surface. The guide slot 342 is sized and configured to receive a guide rail 344, which is coupled to the carriage 320 and extends longitudinally in a forward-to-rearward direction (i.e., the direction of recline adjustment). A cover plate 346 may be coupled to the slider 330 to cover the guide slot 342 and capture the guide rail 344 to the slider 330. The interconnection between the guide rail 344 and the slider 330 allows the slider 330 to translate along the guide rail 344 within the carriage cavity 322 between the forward-recline position and rearward-recline position.

The slider 330 may additionally include a bore 348 extending between the pair of opposed side surfaces 340. In this regard, the bore 348 may extend in a generally perpendicular direction relative to longitudinal extension of the guide slot 342. The bore 348 may be sized and configured to receive an end portion of backrest rod 310 and allow for movement of the backrest rod 310 to facilitate recline adjustment of the backrest 312.

The guide slot 342 and cover plate 346 may collectively define a clamp channel configured to receive a pair of clamps 350. In the exemplary embodiment, a portion of the clamp channel extends into the slider 330 and another portion extends into the cover plate 346. The clamps 350 may include a side-by-side pair of metal sheets sized to reside within the clamp channel. Each sheet may include a central opening 352 similar in size to the guide rail 344. The pair of clamps 350 may be sized to frictionally engage the guide rail 344 when a pressure is applied thereto in a prescribed direction, to effectively lock the position of the slider 330 along the guide rail 344 to prevent further translation of the slider 330 along the guide rail 344. When a counteracting force is applied, the locking force applied by the clamps 350 is reduced or eliminated to allow for movement of the slider 330 along the guide rails 344.

The pressure applied to the clamps 350 may be imparted by a camming body 354 rotatably coupled to the slider 330. The camming body 354 may be rotatable relative to the slider 330 between a locking position and an unlocking position. A leaf spring 356 may extend between the camming body 354 and the carriage 320 to impart a biasing force on the camming body 354 which urges the camming body 354 toward the locking position.

According to one embodiment, the camming body 354 includes a pressing finger 358, a stop finger 360, and an opening 362 extending between opposed surfaces of the camming body 354. The pressing finger 358 is configured to interface with one of the metal clamps 350 to apply the prescribed clamping force thereto when the camming body 354 is in the locking position. The stop finger 360 may interface with one of the metal clamps 350 when the camming body 354 is in the unlocking position to prevent further rotation of the camming body 354 relative to the slider 330.

The opening 362 is sized to receive an end portion of the backrest rod 310 and allow for rotating motion of the camming body 354 relative to the backrest rod 310. In this regard, the opening 362 may be slightly elongated (e.g., oval shaped) to accommodate the rotating motion of the camming body 354 relative to the backrest rod 310. The camming body 354 additionally includes a camming surface 364 that interfaces with a sidewall 326 on the carriage 320.

The configurations of the slider bore 348 and the opening 362 of the camming body 354 may be different from each other, and thus, result in different motions of the slider 330 and camming body 354 when the armrest 302 is raised and lowered relative to the backrest rod 310. In particular, the slider bore 348 may be configured to limit motion of the slider in a generally up-and-down motion, whereas the opening 362 of the camming body 354 may result in the camming body 354 rotating relative to the slider 330. This rotation of the camming body 354 relative to the slider 330 may facilitate transition of the camming body 354 between the locking and unlocking positions.

The camming body 354 is configured such that, from the perspective shown in FIG. 49, when the carriage 320 is raised relative to the backrest rod 310, the engagement of the backrest rod 310 to the camming body 354, as well as the interaction between the camming surface 364 and the sidewall 326 causes the camming body 354 to rotate around a pivot screw in a counterclockwise direction from the locking position (as shown in FIG. 49) toward the unlocking position. Conversely, when the carriage 320 is lowered relative to the backrest rod 310, the interaction between the camming surface 364 and the sidewall 326 causes the camming body 354 to rotate around the pivot screw in a clockwise direction.

Referring now specifically to FIGS. 52-55, at least one of the armrests 302 may additionally include a toggle switch 366, which is pivotally coupled to the lower body 314 thereof. The toggle switch 366 includes a first end portion 368 and a second end portion 370. The first end portion 368 includes a manual engagement surface and the second end portion 370 includes a locking tab 372. The toggle switch 366 may pivot about an axis located between the first and second end portions 368, 370 and may be pivoted between a locked position and an unlocked position. In the locked position, the locking tab 372 engages with a hole 374, opening or recess formed in the carriage 320 to prevent movement of the carriage 320 within the armrest 302, which in turn prevents rocking of the backrest 312. In the unlocked position, the locking tab 372 is released from the carriage 320, and thus, the carriage 320 may move within the armrest 302 to allow for rocking of the backrest 312. A spring 376 may act on the toggle switch 366 to bias the toggle switch 366 toward the unlocked position.

With the basic structure of the armrest assembly described above, an exemplary use of the armrest assembly, and the related functionality follows below. When the folding chair 300 is opened, a user may sit in the chair and decide to adjust the recline position of the backrest 312. To make the adjustment, the user may reach down under each armrest 302 at the rearward end portions 308 thereof, and slightly pull up on each armrest 302. When the armrests 302 are pulled up, the carriage 320 and slider 330 may be moved upwardly relative to the backrest rod 310, which causes the camming body 354 to move from the locking position toward the unlocking position. As such, the locking force applied by the camming body 354 to the clamps 350 is reduced, which allows the slider 330 to move more freely along the guide rail 344. As the slider 330 is moved along the guide rail 344, the position of the backrest rod 310 relative to the armrest 302 is adjusted. FIGS. 44, 52, and 54 show the slider 330 in a forward-recline position, while FIGS. 45, 53, and 55 show the slider 330 in a rearward-recline position. A user may selectively move the backrest 312 to a more upright position (e.g., forward-recline), or alternatively, to a more reclined position (e.g., rearward-recline). The backrest 312 may be moved to any one of a multiplicity of different positions between a maximum upright position and a maximum recline position. In this regard, the folding chair 300 may not be limited by a fixed number of predefined intermediate positions.

Once the backrest 312 is in the desired position, the user may lower the armrests, 302 which results in a lowering of the slider 330 and carriage 320 relative to the backrest rod 310. As a result, the camming body 354 is moved toward the locking position, and the force applied to the clamps 350 increases, which effectively locks the position of the slider 330 along the guide rail 344. As such, the recline of the backrest 312 is fixed in the desired position.

As the user sits in the chair 300, the user may decide to rock in the chair 300 by leaning back slightly against the backrest 312. The backward lean of the user may cause the backrest rod 310 to move in a slight rearward direction. The interconnection of the backrest rod 310 to the carriage 320, via the intervening slider 330 locked in position relative to the carriage 320, may cause the carriage 320 to move relative to the lower body 314 of the armrest 302 toward the rearward-rock position. As the carriage 320 moves toward the rearward-rock position, the tension in the springs 328 increases, which increases a biasing force on the carriage 320 in a direction toward the forward-rock position. When the magnitude of the biasing force is able to counteract the backward lean of the user, the carriage 320 may reverse course and move toward the forward-rock position. Upon reaching the forward-rock position, the user may lean back again, and start the cycle over. The user may continue to rock within the chair 300 as desired.

It is contemplated that within the chair 300, the backrest rod 310 will be tubular, i.e., define a lumen extending longitudinally therethrough. This lumen is adapted to accommodate wiring as may be used to facilitate the electrical connection of the previously described battery pack 228 as may be integrated into the chair 300 to other features thereof, e.g., a port integrated into one of the armrests 302 and/or heating elements integrated into base and back cushions.

In the event the user does not want the backrest 312 to rock, the user may actuate the toggle switch 366 to prevent rocking of the backrest 312. The hole 374 on the carriage 320 may selectively be brought into alignment with the locking tab 372 on the toggle switch 366. When the user presses the toggle switch 366 toward its locking position, the locking tab 372 will be advanced into the hole 374 on the carriage 320 when the locking tab 372 becomes aligned with the hole 374 on the carriage 320. Such alignment may occur at the approximate halfway point between the maximum upright position and the maximum recline position of the backrest 312. The biasing force imparted by the springs 328 on the carriage 320 may create sufficient friction to maintain the locking tab 372 within the hole 374, until a user desires to transition the toggle switch 366 to the unlocking position to allow the backrest 312 to freely rock. A user may move the toggle switch 366 from the locking position toward the unlocking position by pressing on the second end portion of the toggle switch 366.

It is contemplated that, when viewed from the perspective shown in FIGS. 41 and 42, the top end of each of the forward legs 306 may have an elastomeric dampening member integrated therein. Each dampening member is effectively captured between the top end of the corresponding forward leg 306 and the underside of the forward end portion 304 of a respective one of armrests 302. The dampening members function to prevent any undesirable rotational or pivotal movement of the armrests in the absence of the user purposefully pulling up on the same in the aforementioned manner.

Referring now to FIGS. 56-62, the features related to the folding actuation of the folding chair 300 will be described. The folding actuation is facilitated by an actuating assembly include a primary body 378 located below the forward end portion of the seat pad and protruding out of a forward support 380. The primary body 378 includes an outer surface 382 and a base surface 384, with a pair of slots 386 being formed in the base surface 384. The slots 386 may be angled relative to each other, such that the ends of the slots 386 adjacent the outer surface 382 are closer to each other than the opposite ends of the slots 386 (e.g., the distance between the slots 386 increases as the distances from the outer surface 382 increases).

The actuating assembly may also include a pair of pivot bodies 388. Each pivot body 388 may include a first segment 390 and a second segment 392 extending at approximate right angles to each other. Each first segment 390 may be pivotally connected to an extension rod 394 and each second segment 392 may be connected to a pin 396 that is received in a respective slot 386 formed on the primary body 378. The interconnection of the primary body 378 to the extension rods 394 through the intervening pivot bodies 388 allows the extension rods 394 to be drawn toward each other in response to moving the primary body 378 from a neutral position to an actuated position, and are moved away from each other as the primary body 378 returns to the neutral position from the actuated position.

Each extension rod 394 is connected to a first locking body 398 that is configured to engage with a corresponding second locking body 400 connected to the forward leg 306. The first locking body 398 includes a distal end portion having several castellations 402 configured to cooperatively engage with correspondingly spaced tabs 404 on the second locking body 400. When the first locking body 398 is engaged with the second locking body 400, the forward leg 306 is locked in position, and when the first locking body 398 is disengaged from the second locking body 400, the forward leg 306 is free to pivot to facilitate folding of the chair 300. The first locking body 398 may be moved in a medial or inward direction to become disengaged from the second locking body 400, and in an opposite lateral or outward direction to become engaged with the second locking body 400.

When the folding chair 300 is open, the first and second locking bodies 398, 400 are engaged with each other to prevent the chair 300 from inadvertently folding. In this regard, the interconnection of the first and second locking bodies 398, 400 prevents the forward legs 306 from pivoting relative to the armrests 302. To close the folding chair 300, a user presses on the primary body 378 of the actuating assembly, which in turn causes the pins 396 to move within the slots 386, with the pins 396 moving toward the outer surface 382 of the primary body 378. Such movement of the pins 396 within the slots 386 draws the pins 396 closer to each other. The extension rods 394, being connected to the pins 396 via the intervening structure of the pivot bodies 388, are also drawn closer together in response to the pins 396 being drawn closer together. As the extension rods 394 are drawn closer together, the first locking bodies 398 are moved away from the second locking bodies 400 (e.g., the first locking bodies 398 are drawn toward a centerline of the chair 300, which may pass through the primary body 378 between the slots 386), which allows the forward legs 306 to pivot relative to the armrests 302.

The forward legs 306 pivot as part of the collapsing motion of the folding chair 300. With reference now specifically to FIGS. 61 and 62, the forward legs 306 pivot toward the armrests 302, such that the angle therebetween decreases. The forward legs 306 are also pivotally connected to a side support bar 406. The side support bar 406 extends between the forward and rearward legs 306, 408, with the rearward legs 408 also being pivotally coupled to a corresponding the side support bar 406. The rearward end portion 308 of the armrest 302 is pivotally connected to an upper end portion of a rear support bar 410, which is also pivotally connected to the side support bar 406 at the lower end portion of the rear support bar 410. The backrest 312 is also pivotally coupled on each side to the rear support bar 410. The attachment point of the backrest 312 to the rear support bar 410 is along the same axis as the attachment point of the rear support bar 410 to the armrest 302.

When the forward legs 306 pivot toward the armrest 302, the backrest 312 begins to pivot downwardly toward the front of the chair 300, while the lower portion of the backrest 312 (e.g., the portion extending downwardly from the armrest 302) pivots upwardly to provide clearance for the padding located on the seat and backrest 312. As the chair 300 continues toward its collapsed position, the rear support bar 410 pivots toward the side support bar 400, which moves the backrest 312 slightly forward to further assist in articulating the folding chair 300 in a manner which accommodates the padding on the folding chair 300, while also achieving a compact configuration when closed.

Referring now to FIGS. 63-64, there is shown a mechanism to facilitate the selective extension or retraction of the top portion 412 of the backrest 312, as may be desirable to use the backrest 312 as a handle when pulling the collapsed folding chair 300 on the ground. In this regard, the backrest 312 may comprise an extendable top portion 412 that is slidably engaged with a pair of side tubes 414, such that the top portion 412 may be adjusted between an extended position and a retracted position.

The top portion of the backrest 312 may include a button 416 that may be pressed to unlock the top portion 412 from the side tubes 414 to allow for sliding of the top portion 412 between the extended and retracted positions. The button 416 may include a main body 418 having a pair of angled slots 420, similar to the primary body 378 discussed above. Each slot 420 is engaged with a pin 422, that is connected to a sliding body 424, which is in turn connected to one end of a cable 426. The other end of the cable 426 is operative connected to a lock body 428. A plurality of lock apertures may be formed in the side tubes 414 of the backrest 312, with each lock body 428 being receivable within a respective lock aperture to restrict extension or retraction of the top portion 412 relative to the side tubes 414. Thus, movement of the top portion 412 may only be achieved when each lock body 428 has been retracted from the lock apertures. The side tubes 414 of the backrest 312 may include a number of spaced, linearly aligned lock apertures at various heights, which correspond to varying degrees of extension of the top portion 412.

When the main body 418 is pressed inwardly by a user, the sliding bodies 424 are moved toward each other as the pins 422 move within their respective slots 420. Such movement of the sliding bodies 424 pulls on the cables 426, which in turn, pulls the lock bodies 428 out of their lock aperture to allow for extension or retraction of the top portion 412. The user may release the button 416, and a spring 430 may bias the lock body 428 in the direction of engagement with a lock aperture, such that when the lock body 428 is aligned with a lock aperture at the desired position of the top portion 412, the lock body 428 may be advanced into the lock aperture to lock the top portion 412 in place.

Referring now to FIGS. 65-73, there is depicted another embodiment of a folding chair 500 that includes features related to a selectively deployable headrest, an electronic charging port, simplified articulation, and a selectively deployable bracket for supporting additional items, such as a cooler, on the folding chair during transport. In this regard, many of the remaining features of the folding chair 500 are similar to that described above, and thus, the following discussion focuses on the features that are unique to the folding chair 500.

FIGS. 65 and 66 highlight the headrest feature included in the folding chair 500. In particular, the folding chair 500 includes a headrest 502 that is integrated into the backrest 504 of the chair 500. The backrest 504 of the chair 500 may include a main portion 506, a pair of side portions 508 and the headrest 502. The headrest 502 includes a pad 510 extending between the pair of side portions 508 and connected to a pair of support posts 512, which are received within corresponding slots formed in the main portion 506. Each support post 512 may include one or more notches formed therein, which may interface with a spring-biased locking body coupled to the main portion 506 for locking the headrest pad 510 at one or more preset positions relative to the main portion 506 as the headrest pad 510 transitions between a stowed position (see FIG. 65) and an extended position (see FIG. 66). When the headrest pad 510 is in the stowed position, a lower surface of the headrest pad 510 is moved adjacent, and possibly in contact with, an upper surface of the main portion 506. When the headrest pad 510 is in the extended position, the lower surface of the headrest pad 510 is moved away from the upper surface of the main portion 506, which results in a void or space being formed between the headrest pad 510 and the main portion 506. Thus, the headrest pad 510 may be selectively positioned between the stowed position and the extended position to accommodate individuals that may vary in height.

Referring now to FIGS. 67 and 68, the folding chair 500 may include an armrest charging compartment, which is depicted in FIGS. 67 and 68 in an opened configuration. In more detail, one or both of the armrests 514 may include a compartment 516 or cavity formed therein, with a cover 518 pivotally coupled to the armrest 514. When the cover 518 is closed, the compartment 516 is covered and the outer surface of the cover 518 may be generally flush or co-planar with the outer surface of the armrest 514. When the cover 518 is opened, compartment 516 may be accessible to access a charging port 520 located within the compartment 516. The charging port 520 may be a USB port, micro USB port, or other charging ports known by those skilled in the art.

According to one embodiment, the charging port 520 is removably connected to the armrest 514. The charging port 520 may be integrated into a body 522 or block that is insertable into a recess formed in the armrest 514 adjacent the compartment 516. The size and configuration of the body 522 may be complementary to that of the recess. One or more screws may be used to connect the body 522 to the armrest 514. When the body 522 is connected to the armrest 514, the charging port 520 may be in operative electrical communication with a battery or other power supply.

Although the charging port 520 may be used to provide power to a handheld electronic device, such as a smartphone or tablet computer, it is also contemplated that data communications may occur through the charging port 520. In this regard, the charging port 520 may not be limited to simply power transfer but may also allow for data transfer therethrough to other electronic devices that may be integrated into the folding chair 500 or operatively connected to the folding chair 500.

The detachable engagement between the charging port 520 and the armrest 514 may allow for trouble shooting or replacement of the charging port 520 in the event the charging port 52 breaks or stops functioning properly. Though not shown in FIGS. 67 and 68, from the perspectives shown therein, it is contemplated that the wall portion of the armrest 514 which defines the bottom surface of the compartment 516 may include a waterproof grommet or similar structure disposed therein as allows for the passage of an electrical cord from the exterior of the armrest 514 into the interior of the compartment 516 thereof. This arrangement allows one end of the electrical cord to be operatively connected to the charging port 520, with the opposed end being operatively connected to a device such as a smartphone, tablet, etc., while maintaining the cover 518 in its closed configuration.

Referring now to FIGS. 69-72, the folding chair 500 may be configured to accommodate padding on the lower seat portion, as well as the backrest portion, when the folding chair 500 is articulated between its folded configuration and its deployed configuration. In this regard, the folding chair 500 may allow for pivoting of the backrest portion relative to the lower seat portion such that sufficient space is allotted for the padding as the folding chair 500 is folded into its fully collapsed state.

FIG. 69 shows the folding chair 500 in a partially folded configuration, while FIG. 70 shows the folding chair 500 in a fully folded or collapsed configuration. As can be seen in FIG. 70, the backrest padding 524 lies on top of the lower seat padding 526 when fully folded, such that the backrest padding 524 is oriented is generally parallel, overlapping relation to the lower seat padding 526. In this regard, the frame of the folding chair 500 may articulate in a manner which avoids interference between the backrest padding 524 and lower seat padding 526, which may otherwise prevent complete folding of the chair 500.

According to one embodiment, both the backrest frame 546 and the lower leg assembly (e.g., forward legs 534, rear legs 538 and linkage 542) are connected to a lower support plate 528 having a front end portion 530 and a rear end portion 532. The front end portion 530 is pivotally coupled to the pair of forward legs 534, such that the pair of forward legs 534 pivot about a common front pivot axis 536. The rear end portion 532 is pivotally coupled to the pair of rear legs 538, such that the pair of rear legs 538 pivot about a common rear pivot axis 540. The upper end portion of each rear leg 538 is linked to a middle portion of a corresponding forward leg 534 via linkage 542 to allow the forward and rear legs 534, 538 to pivot in concert with each other.

The lower support plate 528 additionally includes an extension 544 at the rear end portion thereof, with the extension 544 extending upwardly from a lower edge of the lower support plate 528. The extension 544 includes a distal end portion, which is pivotally connected to the backrest frame 546, such that the backrest frame 546 pivots relative to the extension 544 about a backrest pivot axis 548. The backrest pivot axis 548 is spaced from the rear pivot axis 540 by a distance D, as shown in FIG. 72.

As shown in FIG. 73, the backrest frame 546 may be formed as a unitary structure and include a narrow lower section 547 which outwardly flares or transitions into a comparatively wider upper section 549. The narrow lower section 547 may be pivotally connected to the lower support plate 528 and may define a width that is slightly smaller than the distance between the pair of opposed extensions 544 of the lower support plate 528. The wider upper section 549 may be greater in width that the lower section 547 to provide more space for supporting the upper back of a user seated in the chair 500. The construction of the backrest frame 546 as a single component devoid of any portions which pivot relative each other is thus consistent to that of the backrest frame 311 of the backrest 312 included in the above-described folding chair 300, as opposed to the two-piece construction comprising the upper back subframe 20 and lower back subframe 22 included in the above-described folding chair 10.

Referring now to FIGS. 73-75, the folding chair 500 may additionally include a selectively deployable support bracket 550 for supporting a cooler or other item thereon when the chair 500 is articulated to its fully folded state. For instance, if a user needs to transport the chair 500 and the cooler from a vehicle to a remote location, such as a sports field located away from where the vehicle may be parked, the user may place the cooler on the deployed support bracket 550 and wheel the chair 500 from the vehicle to the sports field, which may be much easier than carrying the chair 500 and the cooler separately.

The support bracket 550 may be pivotally coupled to the backrest rod 552, which extends transversely across the backrest frame 546. The support bracket 550 may include an elongate member 554 and a plurality of pivot arms 556 extending from the elongate member 554 and each being pivotally connected to the backrest rod 552. In the exemplary embodiment, the support bracket 550 includes three pivot arms 556, although it is contemplated that any number of pivot arms 556 may be included without departing from the spirit and scope of the present disclosure. The combination of the pivot arms 556 and the elongate member 554 provide sufficient structure for supporting the cooler against the backrest of the folding chair 500, particularly when the backrest is held at an angle (e.g., not vertical).

The pivot arms 556 may be spaced from each other, such that adjacent pivot arms 556 may form an opening 558 which may be used to attach a strap or the like around the cooler when the cooler is placed on the support bracket 550.

The support bracket 550 may pivot relative to the backrest frame 546 between a stowed position and a deployed position. When in the stowed position, the elongate member 554 may lie adjacent or against the backrest 504 of the folding chair 500, while in the deployed position, the elongate member 554 may be positioned away from the backrest 504, i.e., extending at about a ninety degree angle relative thereto as seen in FIG. 74. In this regard, transitioning the support bracket 550 from the stowed position to the deployed position results in the elongate member 554 being moved away from the backrest 504, while transition of the support bracket 550 from the deployed position toward the stowed position results in the elongate member 554 being moved toward and ultimately into overlapping contact with the backrest 504. Transition of the support bracket 550 between the stowed and deployed positions may also result in the angle defined by the support bracket 550 and the backrest 504 to change, i.e., the transition of the support bracket 550 from the deployed position toward the stowed position resulting in the angle therebetween decreasing, while transition of the support bracket 550 from the stowed position toward the deployed position resulting in the angle therebetween increasing to the aforementioned maximum of about ninety degrees.

The folding chair 500 may include one or more struts 555 or support straps that extend across the backrest frame 546 to aid in supporting the cooler on the backrest 504 of the folding chair 500. In particular, the struts 555 may bear a portion of the weight of the cooler, as well as transfer the weight across the backrest frame 526. The struts 555 may be formed from metal, a woven material (e.g., nylon), leather, plastic, or other materials known in the art. In the exemplary embodiment, there are two struts 555 positioned in the upper portion of the backrest frame 546 above the support bracket 550, and one strut 555 positioned in the lower portion of the backrest frame 546 below the support bracket 550. However, it is understood that the number and placement of struts 55 is provided as an example and is not intended to limit the scope of the present disclosure.

FIG. 75 shows the folding chair 500 in the folded configuration, with the support bracket 550 in the deployed position, with the telescoping handle 560 extended from the remainder of the backrest frame 546 to facilitate rolling of the folding chair 500 along the ground. With the support bracket 550 deployed, a cooler or other item may be easily supported thereon while rolling the folding chair 500.

What is claimed is:

1. A folding chair comprising:
a pair of armrests;
a backrest rod extending between the pair of armrests and being moveable relative to the pair of armrests;
a backrest frame connected to the backrest rod; and
a lower frame connected to the backrest frame;
the backrest frame being transitional relative to the lower frame between a deployed configuration and a folded configuration, an angle between the lower frame and the backrest frame decreasing as the backrest frame transitions from the deployed configuration toward the folded configuration;
the backrest frame being configured to assume a recline position relative to the pair of armrests when the backrest frame is in the deployed position, the backrest frame being interconnected to the pair of armrests such that the recline position is selectively adjustable within a prescribed range;
the backrest frame being interconnected to the pair of armrests and the lower frame to allow for selective pivotal rocking of the backrest frame relative to the lower frame when the backrest frame is in the recline position.

2. The folding chair recited in claim 1, further comprising:
a pair of cavities located in respective ones of the pair of armrests; and
a pair of carriages located in respective ones of the pair of cavities and interconnected to the backrest rod such that the pair of carriages translate within the respective cavity to facilitate the selective pivotal rocking of the backrest frame.

3. The folding chair recited in claim 2, further comprising a pair of springs, each spring being connected to a respective one of the pair of armrests and a respective one of the pair of carriages to impart a dampening force on the respective carriage.

4. The folding chair recited in claim 2, further comprising a pair of sliders connected to the backrest rod and respective ones of the pair of carriages, the pair of sliders translating relative to the respective ones of the pair of carriages to facilitate the selective adjustment of the recline position.

5. The folding chair recited in claim 4, further comprising a pair of guide rails coupled to respective ones of the pair of sliders, the pair of sliders being translatable along respective ones of the pair of guide rails.

6. The folding chair recited in claim 5, wherein each slider includes a bore which receives a portion of the backrest rod, the backrest rod being moveable within each bore between a first position and a second position, each slider being moveable within the respective one of the pair of carriages when the backrest rod is in the second position.

7. The folding chair recited in claim 6, further comprising a pair of clamps connected to respective ones of the pair of sliders and respective ones of the pair of guide rails and configured to inhibit movement of the respective slider along the respective guide rail when the backrest rod is in the first position.

8. The folding chair recited in claim 1, further comprising a headrest moveable relative to the backrest frame between a stowed position and an extended position, the headrest moving away from the pair of armrests as the headrest moves from the stowed position toward the extended position when the backrest frame is in the deployed configuration.

9. The folding chair recited in claim 8, wherein the headrest translates relative to the backrest frame as it transitions between the stowed position and the extended position.

10. The folding chair recited in claim 1, further comprising a pair of wheels coupled to the backrest frame or the lower frame.

11. The folding chair recited in claim 1, further comprising a charging port located in one of the pair of armrests.

12. The folding chair recited in claim 11, wherein the charging port is removeably coupled to the one of the pair of armrests within which the charging port is located.

13. The folding chair recited in claim 1, further comprising a support bracket pivotally coupled to the backrest frame.

14. A folding chair comprising:
a pair of armrests;
a backrest rod extending between the pair of armrests and being moveable relative to the pair of armrests;
a backrest frame connected to the backrest rod;
a lower frame connected to the backrest frame;
the backrest frame being transitional relative to the lower frame between a deployed configuration and a folded configuration, an angle between the lower frame and the backrest frame decreasing as the backrest frame transitions from the deployed configuration toward the folded configuration;
the backrest frame being interconnected to the pair of armrests and the lower frame to allow for selective pivotal rocking of the backrest frame relative to the lower frame, the backrest rod being interconnected to the pair of armrests such that the backrest rod moves relative to the pair of armrests as the backrest frame pivotally rocks relative to the lower frame.

15. The folding chair recited in claim 14, further comprising:
a pair of cavities located in respective ones of the pair of armrests; and
a pair of carriages located in respective ones of the pair of cavities and interconnected to the backrest rod such that the pair of carriages translate within the respective cavity to facilitate the selective pivotal rocking of the backrest frame.

16. The folding chair recited in claim 15, further comprising a pair of springs, each spring being connected to a respective one of the pair of armrests and a respective one of the pair of carriages to impart a dampening force on the respective carriage.

17. A folding chair comprising:
a pair of armrests;
a backrest rod extending between the pair of armrests and being moveable relative to the pair of armrests;
a pair of sliders connected to the backrest rod;
a backrest frame connected to the backrest rod;
a lower frame connected to the backrest frame;
the backrest frame being transitional relative to the lower frame between a deployed configuration and a folded configuration, an angle between the lower frame and the backrest frame decreasing as the backrest frame transitions from the deployed configuration toward the folded configuration;
the backrest frame being configured to assume a recline position relative to the pair of armrests when the backrest frame is in the deployed position, the backrest frame being interconnected to the pair of armrests such that the recline position is selectively adjustable within a prescribed range, the pair of sliders translating relative to respective ones of the pair of armrests to facilitate the selective adjustment of the recline position.

18. The folding chair recited in claim 17, further comprising a pair of guide rails coupled to respective ones of the pair of sliders, the pair of sliders being translatable along respective ones of the pair of guide rails.

19. The folding chair recited in claim 18, wherein each slider includes a bore which receives a portion of the backrest rod, the backrest rod being moveable within each bore between a first position and a second position, each slider being moveable along the respective ones of the pair of guide rails when the backrest rod is in the second position.

20. The folding chair recited in claim 19, further comprising a pair of clamps connected to respective ones of the pair of sliders and respective ones of the pair of guide rails and configured to inhibit movement of the respective slider along the respective guide rail when the backrest rod is in the first position.
